(19) United States
(12) Patent Application Publication
(10) Pub. No.: US 2025/0282438 A1
(43) Pub. Date: Sep. 11, 2025

(54) BICYCLE COMPONENT

(71) Applicant: Shimano Inc., Osaka (JP)

(72) Inventors: Takafumi NISHINO, Osaka (JP); Takehiko NAKAJIMA, Osaka (JP); Akihiro NISHIO, Osaka (JP); Arisa KANAYAMA, Osaka (JP)

(21) Appl. No.: 18/598,602

(22) Filed: Mar. 7, 2024

(51) Int. Cl. B62J 43/20; B62J 43/30; B62J 45/20; B62J 50/21; B62K 23/06; B62L 3/02; B62M 25/08; H01M 50/249; H01M 50/271

(52) U.S. Cl. CPC B62J 43/20; B62J 43/30; B62J 45/20; B62J 50/21; B62K 23/06; B62L 3/023; B62M 25/08; H01M 50/249; H01M 50/271; H01M 2220/20

(57) ABSTRACT

A bicycle component is basically provided with a rechargeable power source and an electrical switch. The rechargeable power source is configured to be charged by electric power from an external power supply. The electrical switch is configured to be activated by only electric power from the rechargeable power source.

### BACKGROUND

### Technical Field

This disclosure generally relates to a bicycle component. More specifically, the present disclosure relates to a bicycle component having an electrical switch.

### Background Information

In recent years, some bicycles are provided with electric components or devices to make it easier for the rider to operate the bicycle. Examples of such bicycle components include suspensions, transmission devices (e.g., derailleurs, internally geared hubs, etc.), operating devices and seatposts. Some bicycle components are provided with one or more electrical switches to operate the bicycle component. When a bicycle component includes an electrical switch, one or more electric power supplies are provided to the bicycle or the bicycle component to provide electrical power to the electrical switch.

### SUMMARY

Generally, the present disclosure is directed to various features of a bicycle component having an electrical switch.

In view of the state of the known technology and in accordance with a first aspect of the present disclosure, a bicycle component is provided that basically comprises a rechargeable power source and an electrical switch. The rechargeable power source is configured to be charged by electric power from an external power supply. The electrical switch is configured to be activated by only electric power from the rechargeable power source.

With the bicycle component according to the first aspect, electric power can be reliably provided to an electrical switch of the bicycle component using a rechargeable power source that can be recharged by electric power from an external power supply.

In accordance with a second aspect of the present disclosure, the bicycle component according to the first aspect further comprises a holding structure configured to detachably hold the rechargeable power source to the bicycle component.

With the bicycle component according to the second aspect, the rechargeable power source can be removed and reinstalled.

In accordance with a third aspect of the present disclosure, a bicycle component is provided that basically comprises a rechargeable power source, an electrical switch and a holding structure. The rechargeable power source is configured to be charged by electric power from an external power supply. The electrical switch is configured to be activated by electric power from the rechargeable power source. The holding structure is configured to detachably hold the rechargeable power source to the bicycle component.

With the bicycle component according to the third aspect, electric power can be reliably provided to an electrical switch of the bicycle component using a rechargeable power source that can be removed and reinstalled.

In accordance with a fourth aspect of the present disclosure, the bicycle component according to the second aspect or the third aspect is configured so that the holding structure includes an electrical terminal structure electrically coupling the rechargeable power source to the bicycle component.

With the bicycle component according to the fourth aspect, the rechargeable power source can be easily and reliably electrically coupled to the electrical switch of the bicycle component.

In accordance with a fifth aspect of the present disclosure, the bicycle component according to any one of the first aspect to the fourth aspect is configured so that the holding structure includes an accommodating part and a power source cover. The accommodating part is configured to accommodate the rechargeable power source. The accommodating part includes an opening for removing the rechargeable power source from the holding structure. The power source cover is configured to at least partially cover the opening of the accommodating part.

With the bicycle component according to the fifth aspect, the rechargeable power source can be easily removed from the holding structure.

In accordance with a sixth aspect of the present disclosure, the bicycle component according to the fifth aspect is configured so that the holding structure includes a cover fixing structure configured to fix the power source cover relative to the accommodating part.

With the bicycle component according to the sixth aspect, the power source cover can be reliably fixed to the bicycle component for retaining the rechargeable power source to the holding structure.

In accordance with a seventh aspect of the present disclosure, the bicycle component according to any one of the first aspect to the sixth aspect further comprises a base member and an operating member. The base member is configured to be mounted to a bicycle. The operating member is movably coupled to the base member.

With the bicycle component according to the seventh aspect, a user can easily operate the electrical switch us an operating member.

In accordance with an eighth aspect of the present disclosure, the bicycle component according to the seventh aspect is configured so that the operating member is configured to operate an operated device mounted to the bicycle.

With the bicycle component according to the eighth aspect, the operating member can be used to operate an operated device mounted to the bicycle.

In accordance with a ninth aspect of the present disclosure, the bicycle component according to the seventh aspect or the eighth aspect is configured so that the operating member is configured to activate the electrical switch in response to an input to the operating member.

With the bicycle component according to the ninth aspect, the electrical switch can be easily and reliably operated in response to an input to the operating member.

In accordance with a tenth aspect of the present disclosure, the bicycle component according to any one of the seventh aspect to the ninth aspect further comprises an additional operating member movably coupled relative to the base member, the additional operating member being different from the operating member.

With the bicycle component according to the tenth aspect, the bicycle component be used to perform two distinct operations.

In accordance with an eleventh aspect of the present disclosure, the bicycle component according to the tenth aspect is configured so that the additional operating member is configured to operate an additional operated device mounted to the bicycle.

With the bicycle component according to the eleventh aspect, the bicycle component be used to operate two distinct operated devices.

In accordance with a twelfth aspect of the present disclosure, the bicycle component according to the tenth aspect or the eleventh aspect is configured so that the base member includes a proximal end configured to be mounted to the bicycle, and a distal end opposite to the proximal end. The additional operating member is pivotally supported by an axle to pivot with respect to the base member. The axle is disposed closer to the distal end than to the proximal end.

With the bicycle component according to the twelfth aspect, the additional operating member can be conveniently mounted to the bicycle for easy operation.

In accordance with a thirteenth aspect of the present disclosure, the bicycle component according to any one of the tenth aspect to the twelfth aspect is configured so that the electrical switch is provided to at least one of the operating member and the additional operating member.

With the bicycle component according to the thirteenth aspect, the bicycle component can be relatively compact by providing the electrical switch to at least one of the operating member and the additional operating member.

In accordance with a fourteenth aspect of the present disclosure, the bicycle component according to any one of the tenth aspect to the thirteenth aspect further comprises a hydraulic unit configured to operate the additional operated device in response to an input to the additional operating member.

With the bicycle component according to the fourteenth aspect, the bicycle component can be used for operating a hydraulically operated device in response to an input to the additional operating member.

In accordance with a fifteenth aspect of the present disclosure, the bicycle component according to any one of the tenth aspect to the fourteenth aspect is configured so that the operating member is movably mounted to the additional operating member.

With the bicycle component according to the fifteenth aspect, a user can easily operate the operating member and the additional operating member.

In accordance with a sixteenth aspect of the present disclosure, the bicycle component according to any one of the first aspect to the fifteenth aspect further comprises a charging port configured to supply electrical power to the rechargeable power source from the external power supply.

With the bicycle component according to the sixteenth aspect, the rechargeable power source can be recharged without removing the rechargeable power source from the bicycle component.

In accordance with a seventeenth aspect of the present disclosure, the bicycle component according to the sixteenth aspect further comprises a cover member configured to cover the charging port in a case where the cover member is in a covering state.

With the bicycle component according to the seventeenth aspect, the charging port can be protected from contaminants when the charging port is not being used.

In accordance with an eighteenth aspect of the present disclosure, the bicycle component according to any one of the first aspect to the seventeenth aspect further comprises a wireless communicator electrically coupled to the rechargeable power source.

With the bicycle component according to the eighteenth aspect, the bicycle component can wirelessly communicate with another component or device without using a communication cable. Thus, it is possible to omit a communication cable and simplify the installation of the bicycle component.

In accordance with a nineteenth aspect of the present disclosure, the bicycle component according to the eighteenth aspect is configured so that the wireless communicator is configured to transmit information related to the rechargeable power source to an external device.

With the bicycle component according to the nineteenth aspect, a user can reliably manage the rechargeable power source.

In accordance with a twentieth aspect of the present disclosure, the bicycle component according to the eighteenth aspect or the nineteenth aspect further comprises a substrate and an antenna. The substrate supports the wireless communicator. The antenna is provided to the substrate and electrically coupled to the wireless communicator. The substrate is disposed between the rechargeable power source and the antenna.

With the bicycle component according to the twentieth aspect, the rechargeable power source and the antenna can be conventionally provided to the substrate without increasing the size of the substrate.

In accordance with a twenty-first aspect of the present disclosure, the bicycle component according to the twentieth aspect is configured so that the antenna is disposed along a peripheral edge of the substrate.

With the bicycle component according to the twenty-first aspect, reception and transmission of wireless signals can be improved.

In accordance with a twenty-second aspect of the present disclosure, the bicycle component according to the fifth aspect or the sixth aspect further comprises a wireless communicator, a substrate and an antenna. The wireless communicator is electrically coupled to the rechargeable power source. The substrate supports the wireless communicator on a first side. The antenna is provided to a second side of the substrate and electrically coupled to the wireless communicator. The second side faces in an opposite direction to the first side. The rechargeable power source is closer to the power source cover than the antenna.

With the bicycle component according to the twenty-second aspect, the rechargeable power source can be more easily accessed for replacement.

In accordance with a twenty-third aspect of the present disclosure, the bicycle component according to any one of the twentieth aspect to the twenty-second aspect further comprises an electronic controller configured to control supply of electrical power from the rechargeable power source to the wireless communicator based on an output from a detector. The detector is configured to detect a state of at least one of the bicycle and the bicycle component.

With the bicycle component according to the twenty-third aspect, the supply of electric power from the rechargeable power source to the wireless communicator can be appropriately regulated based on an output from a detector.

In accordance with a twenty-fourth aspect of the present disclosure, the bicycle component according to any one of the first aspect to the twenty-second aspect further comprises an electronic controller configured to obtain information related to the rechargeable power source.

With the bicycle component according to the twenty-fourth aspect, information related to the rechargeable power source can be readily used by the electronic controller as needed and/or desired.

In accordance with a twenty-fifth aspect of the present disclosure, the bicycle component according to the twenty-fourth aspect further comprises a notification device electrically coupled to the electronic controller. The electronic controller is configured to control the notification device based on the information.

With the bicycle component according to the twenty-fifth aspect, a user can be easily notified about the status of the rechargeable power source.

Also, other objects, features, aspects and advantages of the disclosed bicycle component will become apparent to those skilled in the art from the following detailed description, which, taken in conjunction with the annexed drawings, discloses preferred embodiments of the bicycle component.

### BRIEF DESCRIPTION OF THE DRAWINGS

Referring now to the attached drawings which form a part of this original disclosure, an illustrative embodiment is shown.

FIG. 1 is a side elevational view of a bicycle that is equipped with a plurality of bicycle components in accordance with various illustrated embodiments of the present disclosure.

FIG. 2 is a front side perspective view of a handlebar area of the bicycle illustrated in FIG. 1.

FIG. 3 is a front side perspective view of an operating device and a portion of a handlebar of the bicycle illustrated in FIG. 1.

FIG. 4 is a front side perspective view, similar to FIG. 3, of the operating device mounted to the handlebar, but in which the grip cover has been removed.

FIG. 5 is a rear side perspective view of the operating device illustrated in FIG. 3.

FIG. 6 is a rear side perspective view, similar to FIG. 5, of the operating device, but in which the grip cover has been removed.

FIG. 7 is a rear end view of the operating device illustrated in FIG. 3 in which the operating members are disposed in rest positions.

FIG. 8 is a rear end view of the operating device illustrated in FIG. 7, but in which one of the operating members has been moved from the rest position of FIG. 7 to an operated position to output a first shift signal.

FIG. 9 is a rear end view of the operating device illustrated in FIGS. 7 and 8, but in which two of the operating members has been moved from their rest positions of FIG. 8 to operated positions to output a second shift signal.

FIG. 10 is an outer side elevational view of the operating device illustrated in FIG. 8, in which the operating members are disposed in their rest positions.

FIG. 11 is an outer side elevational view, similar to FIG. 10, of the operating device illustrated in FIG. 10, but in which the additional operating members has been moved from the rest position of FIG. 10 to an operated position to perform a braking operation.

FIG. 12 is a cross-sectional view of the base member of the operating device of illustrated in FIGS. 1 and 11 showing a hydraulic unit.

FIG. 13 is an outer side elevational view, similar to FIG. 10, of the operating device illustrated in FIGS. 8 and 11, but in which the grip cover has been removed.

FIG. 14 is a partial perspective view of a pommel portion of the operating device of illustrated in FIG. 13.

FIG. 15 is a partial exploded elevational view of the operating device of illustrated in FIGS. 13 and 14, but where an electrical unit has been detached from the base member.

FIG. 16 is a schematic diagram of the control system of the bicycle illustrated in FIG. 1.

FIG. 17 is a cross-sectional view of the electrical unit illustrated in FIGS. 15 and 16 as seen along section line 17-17 of FIG. 14.

FIG. 18 is a partial exploded perspective view of the electrical unit illustrated in FIGS. 15 to 17.

FIG. 19 is a perspective view of an alternate electrical unit in accordance with a second embodiment.

FIG. 20 is a perspective view of the electrical unit illustrated in FIG. 20 in which the battery is shown being inserted into the electrical unit.

FIG. 21 is a partial cross-sectional view of the electrical unit of illustrated in FIG. 20 as seen along section line 21-21 of FIG. 19.

FIG. 22 is a partial exploded perspective view of the electrical unit illustrated in FIGS. 19 to 21.

FIG. 23 is a partial exploded perspective view of an alternate electrical unit in accordance with a third embodiment.

FIG. 24 is a partial cross-sectional view of the electrical unit illustrated in FIG. 23.

FIG. 25 is a partial exploded perspective view of an alternate electrical unit in accordance with a fourth embodiment.

FIG. 26 is a partial cross-sectional view of the electrical unit illustrated in FIG. 25.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

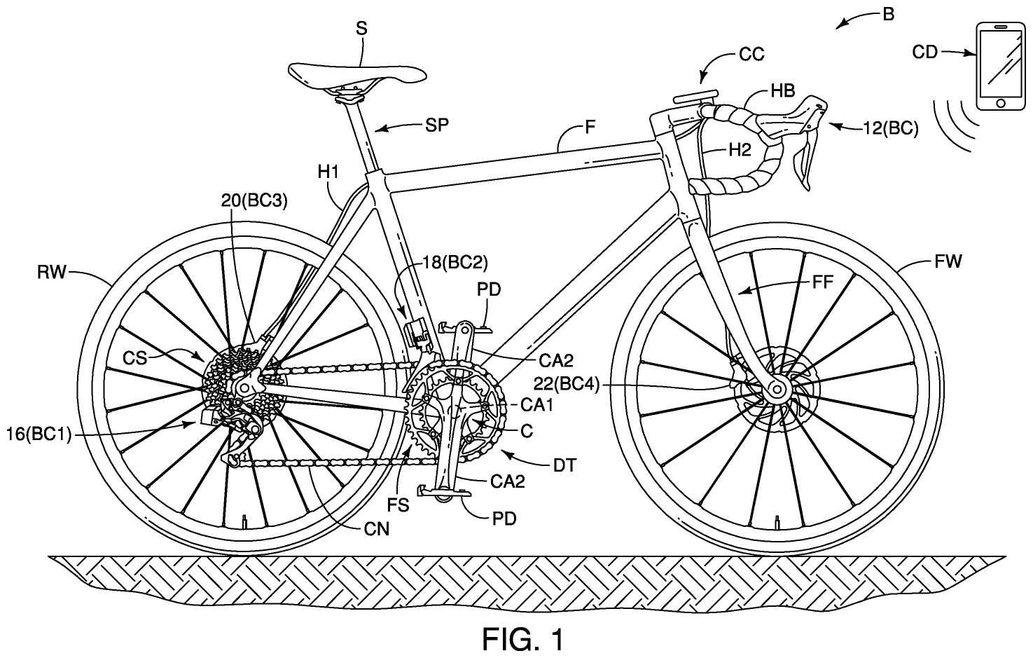

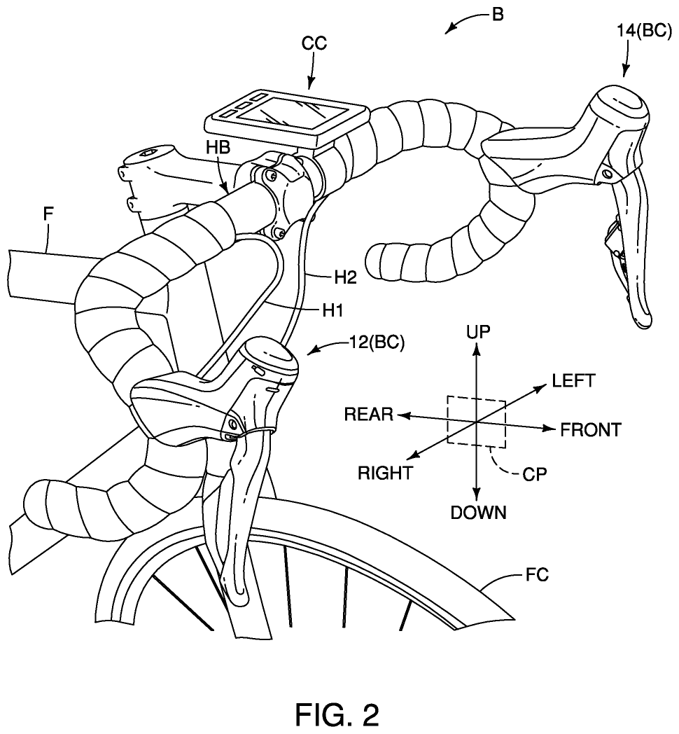

Referring initially to FIGS. 1 and 2, a bicycle B is illustrated that is equipped with a control system 10 in accordance with illustrated embodiments. Here, in the first embodiment, the control system 10 basically includes at least two bicycle components. The term “bicycle component BC” as used herein can be used to generically refer to all of the bicycle components of the bicycle B. Here, in one configuration of the control system 10, the at least one bicycle component BC includes a first operating device 12, a second operating device 14, a first operated device 16, a second operated device 18, a third operated device 20 and a fourth operated device 22. In the first embodiment, as explained below, the first operating device 12 is used to operate the first operated device 16, the second operated device 18 and the third operated device 20. Accordingly, the first operating device 12 will also be referred to as the bicycle component BC, the first operated device 16 will also be referred to as the first bicycle component BC1, the second operated device 18 will also be referred to as the second bicycle component BC2 and the third operated device 20 will also be referred to as the second bicycle component BC3.

It will be apparent from this disclosure that some of the bicycle components of the control system 10 can be omitted as needed and/or desired. Moreover, it will be apparent from this disclosure that other types of bicycle components can be added to the control system 10 as needed and/or desired. In addition, the bicycle component BC of the control system 10 is not limited to an operating device. Rather, the bicycle component BC of the control system 10 one of a gear changing device, a suspension, an adjustable seatpost, a brake device, a display device and a drive assist device.

Here, in the first embodiment, the control system 10 further includes a communication device CD. While FIG. 1 illustrates the communication device CD as a smartphone that is not mounted to the bicycle B, it will be apparent from this disclosure that the communication device CD can be mounted to the bicycle B as a cycle computer. Also, while the communication device CD is preferably a smartphone as shown, the communication device CD can be some other mobile device such as a smart watch, a wireless headphone, a tablet, a laptop, a cycle computer, etc. The communication device CD can also be referred to as an external device. The term “external device” as used herein refers to a device that is external with respect to the bicycle component BC. For example, an external device includes a cycle computer, a smartphone, a tablet, a personal computer, etc. Preferably, the external device includes a touch panel. In the case of a smartphone, for example, the external device can have a first function related to the bicycle B and a second function other than a function related to the bicycle B. For example, the first function of the external device can include one or more of diagnosing, adjusting, notifying, controlling and updating of a bicycle component, while the second function of the external device can include, for example, telephoning, e-mailing, web browsing, gaming, etc.

As shown in FIG. 1, basically, the bicycle B includes a frame F that is supported by a rear wheel RW and a front wheel FW. A front suspension fork FF is pivotally coupled at its upper end to the frame F, and rotatably supports the front wheel FW at its lower end. The bicycle B further includes a handlebar HB mounted to the upper end of the front fork FF for steering the front wheel FW. The rear wheel RW is rotatably mounted to a rear end of the frame F. The seatpost SP is mounted to a seat tube of the frame F in a conventional manner and supports a bicycle seat or saddle S in any suitable manner. The bicycle B further includes a cycle computer CC mounted to the handlebar HB.

The bicycle B further includes a drivetrain DT. Here, for example, the drivetrain DT is a chain-drive type that includes a crank C, a plurality of front sprockets FS, a plurality of rear sprockets CS and a chain CN. The crank C includes a crank axle CA1 and a pair of crank arms CA2. The crank axle CA1 is rotatably supported to the front frame body FB via a bottom bracket in a conventional manner. The crank arms CA2 are provided on opposite ends of the crank axle CA1. A pedal PD is rotatably coupled to the distal end of each of the crank arms CA2. While the drivetrain DT is illustrated as a chain-drive type of drivetrain, the drivetrain DT can be selected from any type of drivetrain, and can be a belt-drive type or a shaft-drive type. The front sprockets FS are provided on the crank C to rotate integrally with the crank axle CA1. The rear sprockets CS are provided on a hub of the rear wheel RW. The chain CN runs around the front sprockets FS and the rear sprockets CS. A human driving force is applied to the pedals PD by a rider such that the driving force is transmitted via the front sprockets FS, the chain CN and the rear sprockets CS to the rear wheel RW.

As seen in FIG. 2, the first operating device 12 and the second operating device 14 are coupled to the handlebar HB in an installed state. Here, the handlebar HB is a drop handlebar. However, the first operating device 12 and the second operating device 14 can be reconfigured to be used with other types of handlebars, as needed and/or desired. The bicycle B has a center plane CP vertically bisecting the frame F of the bicycle B in a longitudinal direction (a front to rear direction). The center plane CP passes through a center of the frame F in a width direction (a left to right direction) of the frame F. Thus, the center plane CP separates a left side of the bicycle B from a right side of the bicycle B. The following directional terms “front,” “rear,” “forward,” “rearward,” “left,” “right,” “lateral,” “longitudinal”, “upward,” and “downward,” as well as any other similar directional terms, refer to those directions which are determined on the basis of a rider sitting upright on a seat of the bicycle B while facing the handlebar HB of the bicycle B.

Here, the first operating device 12 and the second operating device 14 are road brifters, which are operating devices that include both a braking function and a shifting function in a single unit that is mounted to the bicycle B. Here, the first operating device 12 is configured to at least control the first operated device 16 and the third operated device 20. On the other hand, the second operating device 14 is configured to at least control the second operated device 18 and the fourth operated device 22. Also, here, the first operated device 16 and the second operated device 18 are transmission devices, which are configured to change a gear ratio of the drivetrain DT of the bicycle B. The third operated device 20 and the fourth operated device 22 are brake devices, which are configured to apply a braking force to decelerate and/or stop rotation of either the rear wheel RW or the front wheel FW of the bicycle B.

Referring back to FIG. 1, in the first embodiment, the first operating device 12 is configured to wirelessly communicate with the first operated device 16 (e.g., a rear derailleur) and/or the second operated device 18 (e.g., a front derailleur). Alternately, the first operating device 12 can be configured to communicate with the first operated device 16 and/or the second operated device 18 via one or more wires. Likewise, the second operating device 14 can also be configured to wirelessly communicate with the first operated device 16 (e.g., a rear derailleur) and/or the second operated device 18 (e.g., a front derailleur). Alternately, the second operating device 14 can be configured to communicate with the first operated device 16 and/or the second operated device 18 via one or more wires. Thus, the first operating device 12 and the second operating device 14 can use wired communication and/or wireless communication, as needed and/or desired.

Here, the first operated device 16 is an electric rear derailleur, and the second operated device 18 is an electric front derailleur. The first operated device 16 (e.g., a rear derailleur) is configured to shift the chain CN between the rear sprockets CS in response to either an automatic shift signal from the cycle computer CC, or a user inputted shift signal from either the first operating device 12 or the second operating device 14. The second operated device 18 (e.g., a front derailleur) is configured to shift the chain CN between the front sprockets FS in response to either an automatic shift signal from the cycle computer CC, or a user inputted shift signal either the first operating device 12 or the second operating device 14.

In the first embodiment, the first operating device 12 and the second operating device 14 are configured to selectively operate in a full synchronized shift mode, a semi-synchronized shift mode and a full manual shift mode. In the full synchronized shift mode, the second operated device 18 (e.g., a front derailleur) is automatically shifted in response to the first operating device 12 being operated to shift the first operated device 16 (e.g., a rear derailleur). In the semi-synchronized shift mode, the first operated device 16 (e.g., a rear derailleur) is automatically shifted in response to the second operating device 14 being operated to shift the second operated device 18 (e.g., a front derailleur). In the full manual shift mode, the first operating device 12 is selectively operated to shift the first operated device 16 (e.g., a rear derailleur), and the second operating device 14 is selectively operated to shift the second operated device 18 (e.g., a front derailleur). Also, in a fully automatic transmission mode, the first operated device 16 (e.g., a rear derailleur) and the second operated device 18 (e.g., a front derailleur) can be automatically shifted without using either the first operating device 12 or the second operating device 14. For example, the first operated device 16 (e.g., a rear derailleur) and/or the second operated device 18 (e.g., a front derailleur) can be automatically shifted based on a cadence of the crank C and the torque applied to the crank arms CA2.

Still referring to FIG. 1, in the first embodiment, the first operating device 12 is operatively coupled to the third operated device 20 (e.g., a rear hydraulic brake device) via a hydraulic hose H1 to perform a braking operation. Similarly, as seen in FIG. 2, the second operating device 14 is operatively coupled to the fourth operated device 22 (e.g., a front hydraulic brake device) via a hydraulic hose H2 to perform a braking operation. The hydraulic hoses H1 and H2 are conventional structures commonly used in the bicycle field. Alternatively, the third operated device 20 and the fourth operated device 22 can be electric brake devices that are controlled by either wireless communication or wired communication as needed and/or desired.

Broadly speaking, the first operating device 12 and the second operating device 14 are used for selectively operating at least one other bicycle components of the bicycle B. The second operating device 14 is a mirror image of the first operating device 12. Thus, the second operating device 14 will not be discussed in further detail. Rather, it will be apparent from this disclosure that the following description of the first operating device 12 also describes the second operating device 14.

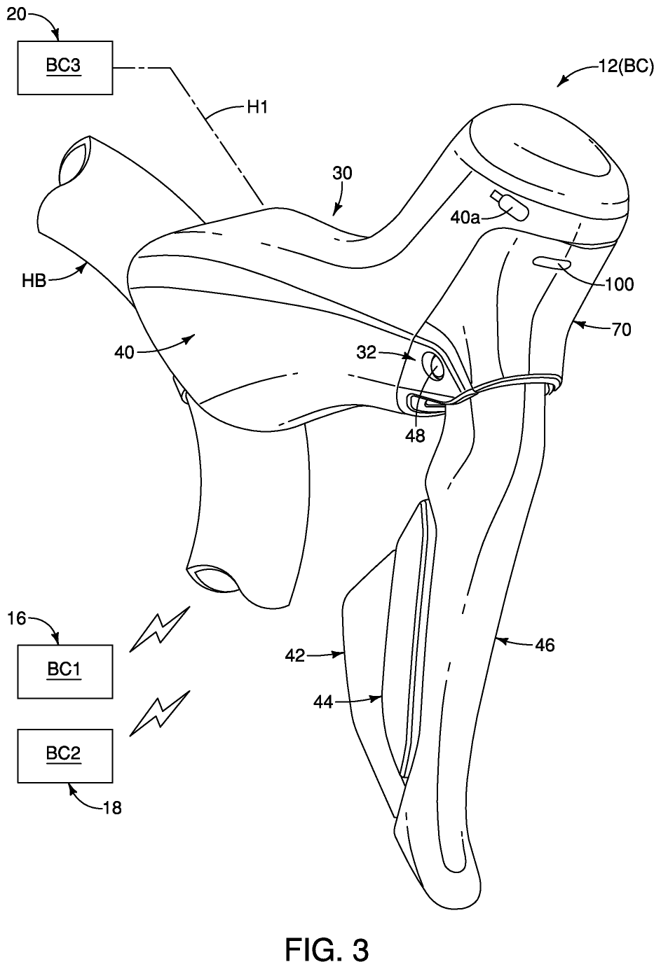

Referring now to FIGS. 3 to 11, the first operating device 12 will now be discussed in further detail. Basically, the bicycle component BC (the first operating device 12) comprises a base member 30. The base member 30 is configured to be mounted to the bicycle B. In the first embodiment, the base member 30 is configured to be coupled to the handlebar HB. In particular, the base member 30 includes a bracket or main body 32 and a mounting part 34. The mounting part 34 is fixed to the main body 32. The mounting part 34 is configured to be coupled to a curved portion of the handlebar HB. Of course, the first operating device 12 can be configured to be mounted on other portions of the bicycle B as needed and/or desired. Thus, the configuration of the body 32 and the mounting part 34 may changed depending on where the bicycle component BC is mounted to the bicycle B.

Here, preferably, the main body 32 is made of a resin material. For example, the main body 32 is made of a hard-plastic material (resin), which can be reinforced with fibers as needed and/or desired. The resin of the main body 32 is a rigid material that is suitable for a rider to grip and lean on during riding. The resin of the main body 32 is also lightweight such that the overall weight of the first operating device 12 can be minimized. However, the main body 32 can be made of other suitable materials as needed and/or desired.

The main body 32 of the base member 30 includes a proximal end 32a and a distal end 32b. The proximal end 32a is configured to be mounted to the bicycle B. The distal end 32b is opposite to the proximal end 32a. The proximal end 32a is provided with the mounting part 34 for mounting to the handlebar HB. In particular, the mounting part 34 is attached to the proximal end 32a of the main body 32 such that the mounting part 34 protrudes from the proximal end 32a of the main body 32. Thus, the proximal end 32a is configured to be coupled to the handlebar HB by the mounting part 34. The proximal end 32a of the main body 32 can also be referred to a mounting end of the main body 32. On the other hand, the distal end 32b can also be referred to as a free end of the main body 32 in that the main body 32 is cantilever relative to the proximal end 32a in a state where the bicycle component BC is mounted to the handlebar HB.

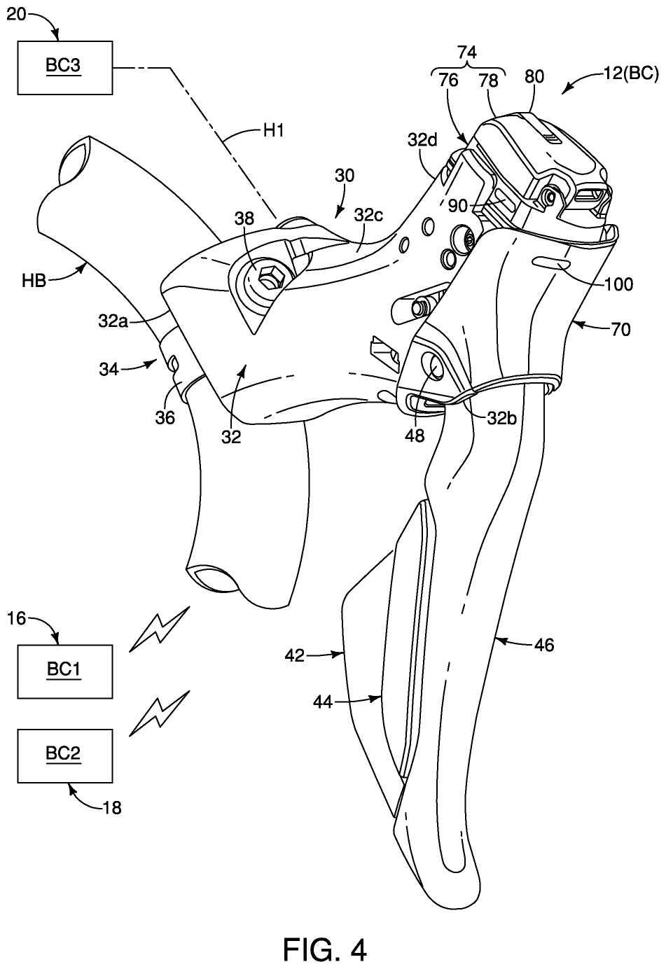

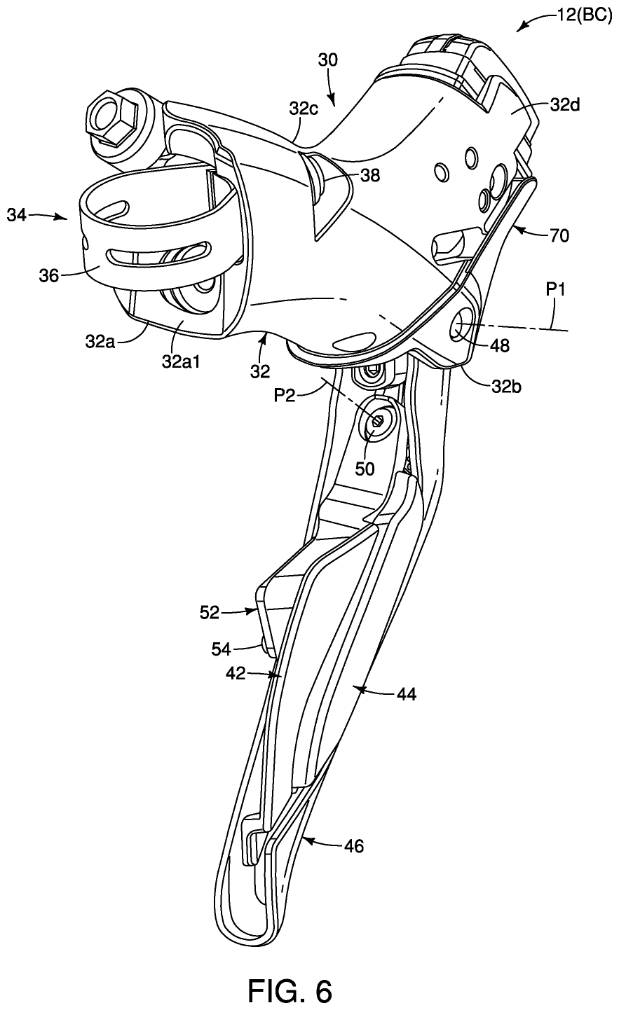

The mounting part 34 is configured to be mounted to the bicycle handlebar HB. In the first embodiment, the mounting part 34 is configured to be mounted to the right side of the handlebar HB. Alternatively, the mounting part 34 is configured to be mounted to the left side of the handlebar HB as needed and/or desired. The mounting part 34 is attached to the main body 32 such that the mounting part 34 is disposed in a handlebar receiving recess 32al of the proximal end 32a. The main body 32 is a stationary member when mounted to the handlebar HB by the mounting part 34. Since the main body 32 is fixed to the handlebar HB by the mounting part 34, the base member 30 constitutes a fixed member with respect to the handlebar HB. The mounting part 34 is preferably a conventional band clamp or similar structure that is used in a road shifter for gripping the handlebar HB. Here, as seen in FIGS. 4 and 6, the mounting part 34 includes a clamping band 36 and a fastener 38 (e.g., a nut and bolt) for gripping the handlebar HB. Since the mounting part 34 can be any suitable mounting structure, the mounting part 34 will not be discussed or illustrated in further detail herein.

In the first embodiment, the main body 32 of the base member 30 further includes a grip portion 32c and a pommel portion 32d. The grip portion 32c extends from the proximal end 32a to the distal end 32b. The pommel portion 32d is provided adjacent to the distal end 32b. In other words, the pommel portion 32d is part of the distal end portion of the base member 30. The pommel portion 32d is an upwardly protruding portion that protrudes upwardly relative to the grip portion 32c in a state where the base member 30 is mounted to the curved portion of the handlebar HB. The grip portion 32c is sized for the rider to grip and lean on during riding. Thus, the rider can grip the grip portion 32c between the proximal end 32a and the pommel portion 32d.

As mentioned above, riders sometimes grip the main body 32 and lean on the main body 32 during riding. In view of this situation, it is desirable to provide a comfortable feeling for the rider's hand while the rider is gripping the main body 32. Thus, the main body 32 is preferably covered with a grip cover 40 (also called a base cover). The grip cover 40 partially covers the main body 32 as seen in FIGS. 2 and 3. Here, the grip cover 40 covers the grip portion 32c, and also partially covers the pommel portion 32d. Thus, the grip cover 40 provides a cushion to the grip portion 32c of the base member 30, and also provides an attractive appearance for the base member 30. In this situation, the grip cover 40 is made of an elastomeric material. For example, the grip cover 40 is made of a flexible rubber material. The grip cover 40 has a tubular configuration such that the grip cover 40 is stretched over the base member 30. In particular, the grip cover 40 is stretched over the grip portion 32c of the main body 32 and the pommel portion 32d of the main body 32. In other words, the grip cover 40 is an elastic piece such as rubber that partially covers the outside surface of the base member 30 in the areas of the grip portion 32c and the pommel portion 32d.

Referring to FIGS. 3 and 4, in the first embodiment, as mentioned above, the first operating device 12 is configured to be used for operating the first operated device 16 (e.g., a rear derailleur), the second operated device 18 (e.g., a front derailleur) and the third operated device 20 (e.g., a rear hydraulic brake device). In FIGS. 3 and 4, the first operated device 16 (e.g., a rear derailleur) will be referred to as the first bicycle component BC1, the second operated device 18 (e.g., a front derailleur) will be referred to as the second bicycle component BC2, and the third operated device 20 (e.g., a rear brake device). Thus, in the first embodiment, as mentioned above, the first operating device 12 is a bicycle operating device that is configured to perform a braking operation and a shifting operation.

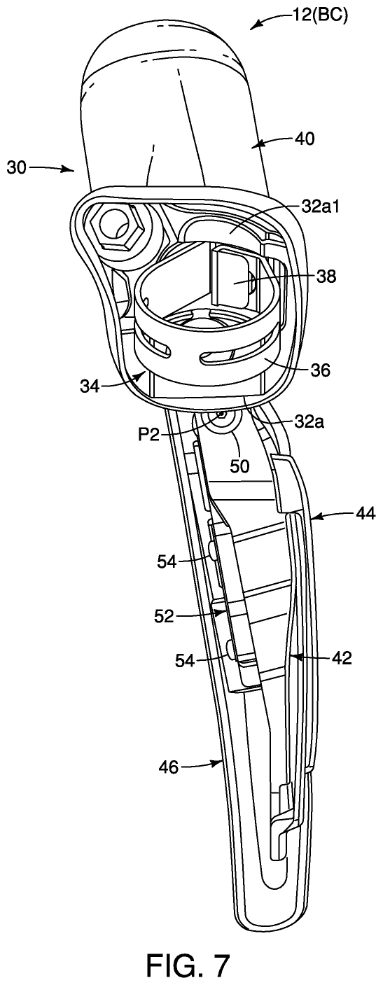

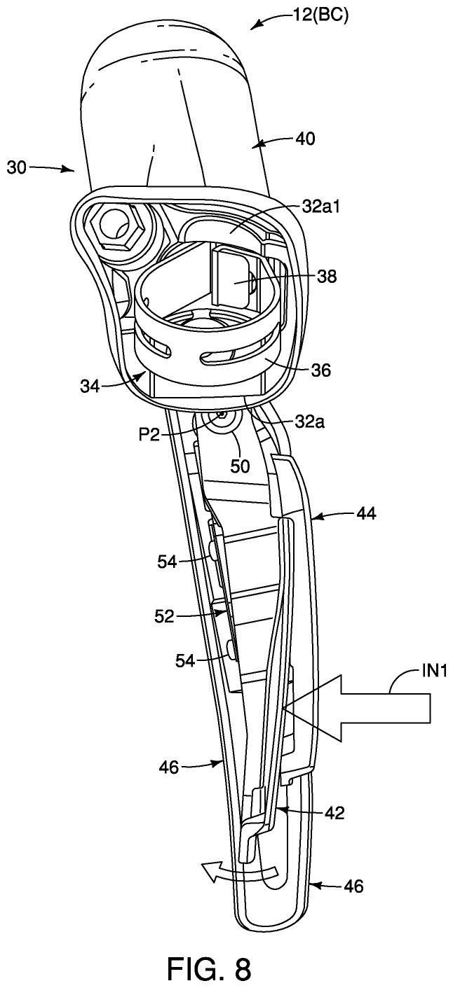

Referring now to FIGS. 3 to 11, the bicycle component BC (e.g., the first operating device 12) further comprises an operating member 42. The operating member 42 is configured to operate an operated device mounted to the bicycle B. Here, the operating member 42 is configured to operate the first operated device 16 (e.g., a rear derailleur) and the second operated device 18 (e.g., a front derailleur). Basically, the operating member 42 is movably coupled relative to the base member 30. In particular, the operating member 42 is configured to pivot relative to the base member 30 to operate at least one of the first operated device 16 (e.g., a rear derailleur) and the second operated device 18 (e.g., a front derailleur). More specifically, the operating member 42 operates at least one of the first operated device 16 (e.g., a rear derailleur) and the second operated device 18 (e.g., a front derailleur) in response to the operating member 42 being pivoted from a rest position (see FIG. 7) to an operated position (see FIG. 8). The operating member 42 is biased to the rest position. In other words, the operating member 42 automatically returns to the rest position upon the operating member 42 being released by the rider after the operating member 42 is operated to perform the shifting operation.

The term “rest position” as used herein refers to a state in which a movable part (e.g., the operating member 42) remains stationary without the need of a user or other external force intervening (e.g., holding the operating member 42) to establish a state corresponding to the rest position. Thus, the term “rest position” can also be referred to as a non-operated position. The terms “operated position” and “actuated position” as used herein refer to a position at which the movable part (e.g., the operating member 42) has been moved by a user from a rest position.

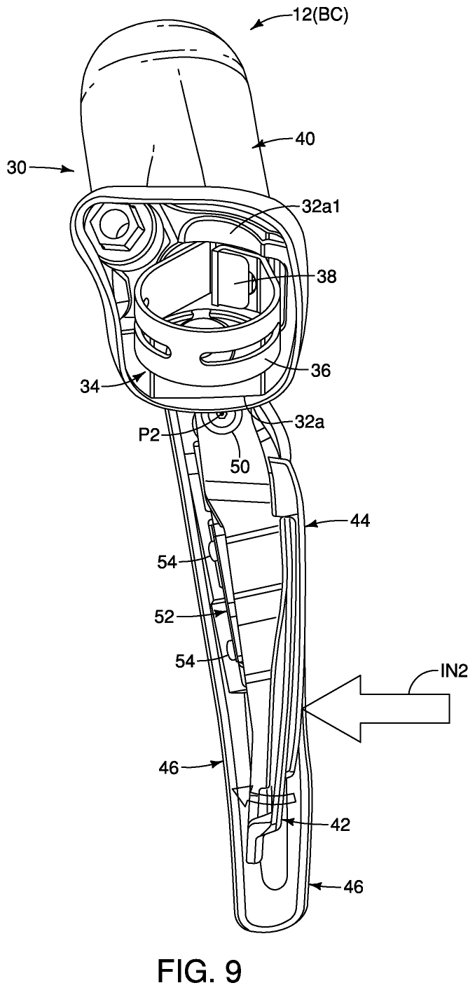

Here, in the first embodiment, the bicycle component BC (e.g., the first operating device 12) further comprises another operating member 44 that is configured to operate an operated device mounted to the bicycle B. Here, the operating member 44 is configured to operate the first operated device 16 (e.g., a rear derailleur) and the second operated device 18 (e.g., a front derailleur). The operating member 42 can be referred to as the first operating member 42 or a first shift operating member 42 in the first embodiment. Also, the operating member 44 can be referred to as the second operating member 44 or a second shift operating member 44 in the first embodiment. Depending on the construction of the bicycle component BC (e.g., the first operating device 12), the second operating member 44 can be omitted. In particular, the second operating member 44 is configured to pivot relative to the base member 30 to operate at least one of the first operated device 16 (e.g., a rear derailleur) and the second operated device 18 (e.g., a front derailleur). More specifically, the second operating member 44 operates at least one of the first operated device 16 (e.g., a rear derailleur) and the second operated device 18 (e.g., a front derailleur) in response to the second operating member 44 being pivoted from a rest position (see FIG. 7) to an operated position (see FIG. 9). The second operating member 44 is biased to the rest position. In other words, the second operating member 44 automatically returns to the rest position upon the second operating member 44 being released by the rider after the second operating member 44 is operated to perform the shifting operation.

In fully manual mode, the first operating member 42 can be used for upshifting the first operated device 16 (e.g., a rear derailleur) for shifting the chain CN to a smaller one of the sprockets CS. Also, in fully manual mode, the second operating member 44 can be used for downshifting the first operated device 16 (e.g., a rear derailleur) for shifting the chain CN to a larger one of the sprockets CS. In full synchronized shift mode, the first operated device 16 (e.g., a rear derailleur) and the second operated device 18 (e.g., a front derailleur) are in response to the first operating device 12 one of the first operating member 42 and the second operating member 44 being operated.

Here, in the first embodiment, the bicycle component BC (e.g., the first operating device 12) further comprises an additional operating member 46. The additional operating member 46 is movably coupled to the base member 30. The additional operating member 46 is different from the operating member 42. The additional operating member 46 is configured to operate an additional operated device mounted to the bicycle B. In the illustrated embodiment, the additional operating member 46 is configured to operate the third operated device 20 (e.g., a rear hydraulic brake device).

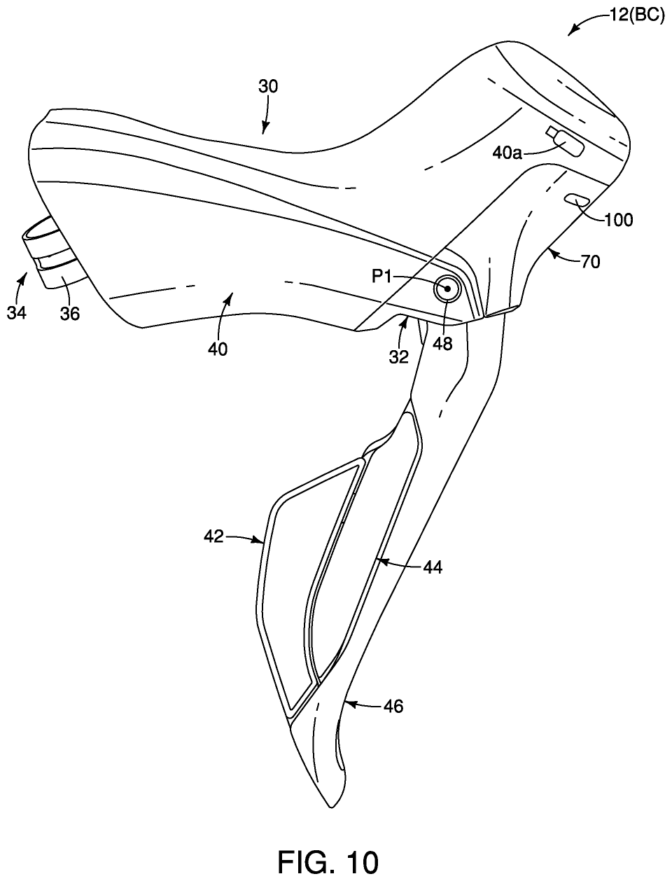

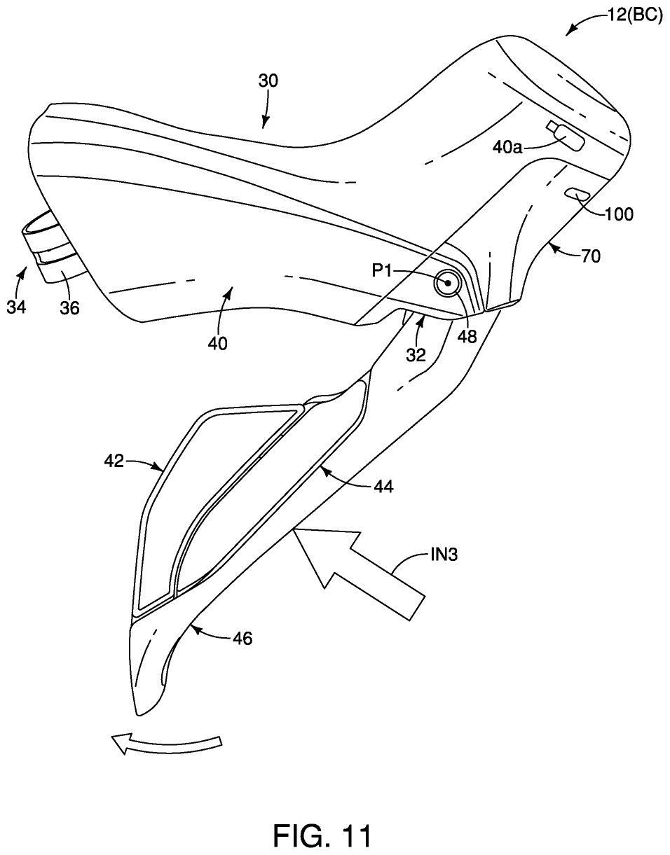

Here, as seen in FIGS. 10 and 11, the additional operating member 46 is a brake lever that is pivotally mounted to the main body 32 of the base member 30. In particular, the additional operating member 46 is pivotally supported by an axle 48 to pivot with respect to the base member 30. Here, the axle 48 is press-fitted into a bore provided in the main body 32 of the base member 30. The axle 48 defines a first pivot axis P1. The axle 48 is disposed closer to the distal end 32b than to the proximal end 32a. The additional operating member 46 is configured to operate the third operated device 20 (e.g., a rear hydraulic brake device) in response to the additional operating member 46 being pivoted from a rest position (see FIG. 10) to an operated position (see FIG. 11). Thus, the additional operating member 46 can be referred to as the third operating member 46 or a brake operating member 46 in the first embodiment. The additional operating member 46 is biased to the rest position. In other words, the additional operating member 46 automatically returns to the rest position upon the additional operating member 46 being released by the rider after the additional operating member 46 is operated to perform the braking operation.

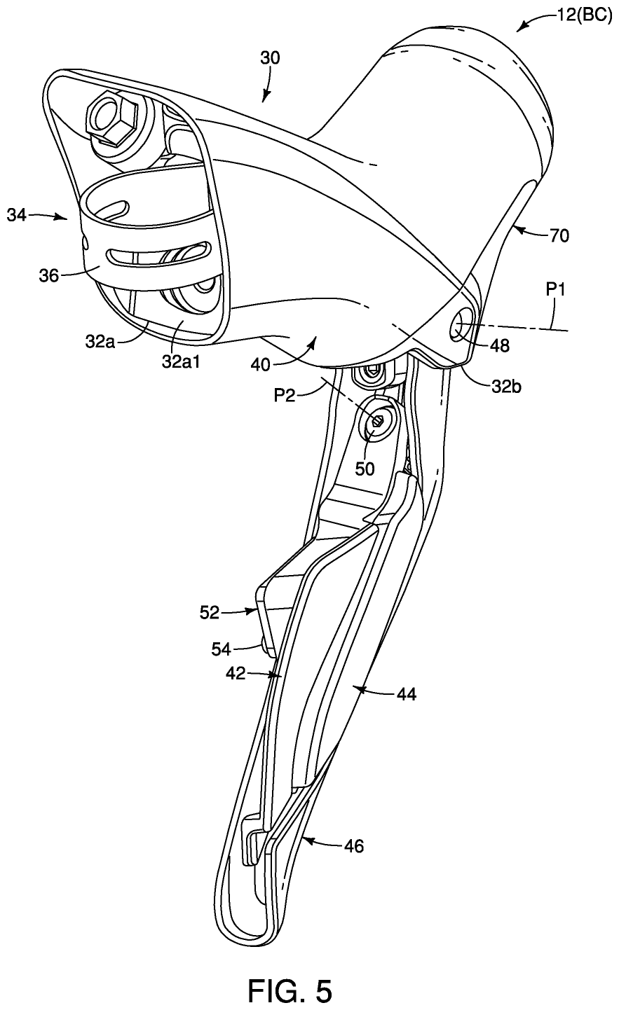

Referring to FIGS. 5 to 9, the operating member 42 is movably mounted to the additional operating member 46. In particular, the first operating member 42 is pivotally mounted to the additional operating member 46 by an axle 50. The axle 50 defines a second pivot axis P2. The second pivot axis P2 is different from the first pivot axis P1. Here, the first pivot axis P1 extends in a direction non-parallel to the second pivot axis P2 as viewed from above in a direction perpendicular to the first pivot axis P1 and the second pivot axis P2. More specifically, the first pivot axis P1 extends perpendicularly to the second pivot axis P2 as viewed from above in a direction perpendicular to the first pivot axis P1 and the second pivot axis P2. Here, the axle 50 is a threaded fastener that is attached a rear side of the additional operating member 46. In the first embodiment, the second operating member 44 is also pivotally mounted to the rear side of the additional operating member 46 by the axle 50.

Still referring to FIGS. 5 to 9, the basic operations of the first operating member 26 and the second operating member 44 will now be discussed. The bicycle component BC (e.g., the first operating device 12) further comprises an electrical switch 52. The electrical switch 52 can be a conventional electrical switch. Here, the electrical switch 52 provided with a first switch actuator that is operated by the first operating member 26 and a second switch actuator that is operated by the second operating member 44. Alternatively, depending on the operating member, the electrical switch 52 can be provided with a single switch actuator as needed and/or desired. The electrical switch 52 is provided to at least one of the operating member 42 and the additional operating member 46. In the first embodiment, the electrical switch 52 is attached a rear side of the additional operating member 46 by a pair of screws 54. Thus, the electrical switch 52 is stationary with respect to the additional operating member 46.

The operating member 42 is configured to activate the electrical switch 52 in response to an input to the operating member 42. Likewise, the second operating member 44 is configured to activate the electrical switch 52 in response to an input to the second operating member 44. Thus, the electrical switch 52 is selectively operated by user inputs to the first operating member 26 and/or the second operating member 44. FIGS. 5 to 7 show the first operating member 26 and the second operating member 44 in their rest position.

In the case where a user input IN1 is inputted to the first operating member 42 as seen in FIG. 8, the first operating member 42 is pivoted about the second pivot axis P2 from the rest position (see FIGS. 5 to 7) to the operated position (see FIG. 8). This movement of the first operating member 42 depresses a first actuator of the electrical switch 52 to output a first shift signal to perform a first shift operation. For example, in fully manual mode, the first shift signal is an upshift signal that is sent to the first operated device 16 (e.g., a rear derailleur) for shifting the chain CN to a smaller one of the sprockets CS. Thus, in fully manual mode, an upshift operation is performed in response to operation of the first operating member 42. Also, when the first operating member 42 is pivoted about the second pivot axis P2 from the rest position (see FIGS. 5 to 7) to the operated position (see FIG. 8), the second operating member 44 does not move, but remains in the rest position.

In the case where a user input IN2 is inputted to the second operating member 44 as seen in FIG. 9, the second operating member 44 is pivoted about the second pivot axis P2 from the rest position (see FIGS. 5 to 7) to the operated position (see FIG. 9). This movement of the second operating member 44 depresses a second actuator of the electrical switch 52 to output a second shift signal to perform a second shift operation. For example, in fully manual mode, the second shift signal is a downshift signal that is sent to the first operated device 16 (e.g., a rear derailleur) for shifting the chain CN to a larger one of the sprockets CS. Thus, in fully manual mode, a downshift operation is performed in response to operation of the second operating member 44. Also, when the second operating member 44 is pivoted about the second pivot axis P2 from the rest position (see FIGS. 5 to 7) to the operated position (see FIG. 9), the first operating member 42 may move the second operating member 44.

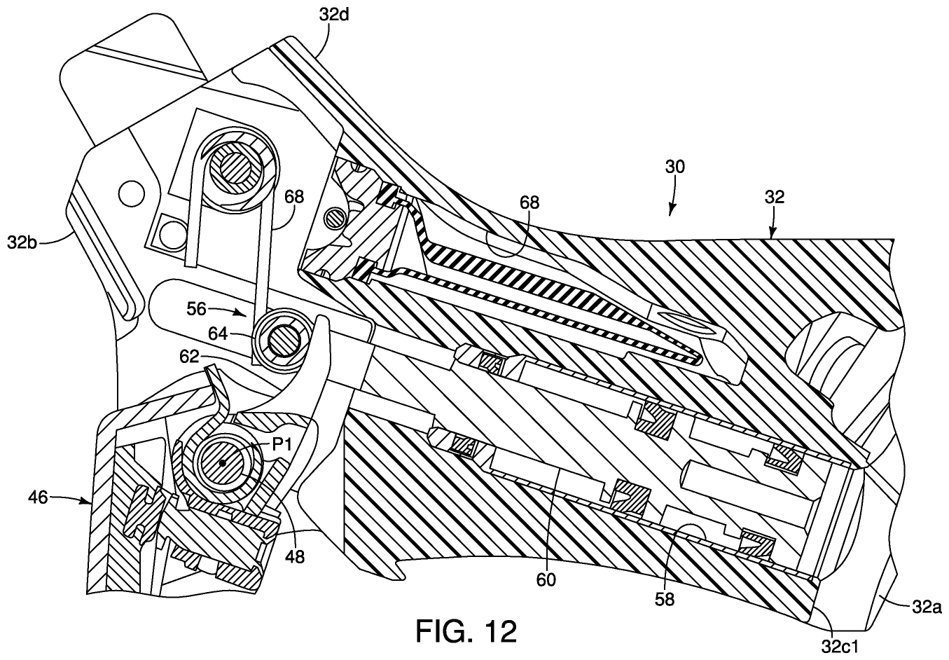

Referring to FIGS. 10 to 12, the basic operation of the additional operating member 46 (e.g., the brake lever) will now be discussed. As seen in FIG. 12, the bicycle component BC (e.g., the first operating device 12) further comprises a hydraulic unit 56. The hydraulic unit 56 is configured to operate the additional operated device in response to an input to the additional operating member 46. Here, in the first embodiment, the additional operated device is the third operated device 20 (e.g., a rear hydraulic brake device). Thus, the additional operating member 46 (e.g., the brake lever) actuates the hydraulic unit 56 to operate the third operated device 20 (e.g., a rear hydraulic brake device).

Basically, the additional operating member 46 is configured to pivot between the rest position (FIG. 10) and an operated position (FIG. 11) in about the first pivot axis P1 to operate the third operated device 20 (e.g., a rear hydraulic brake device). In the case where a user input IN3 is inputted to the additional operating member 46 as seen in FIG. 11, the additional operating member 46 is pivoted about the first pivot axis P1 from the rest position (see FIG. 10) to the operated position (see FIG. 11). This movement of the additional operating member 46 actuates the hydraulic unit 56 to operate the third operated device 20 (e.g., a rear hydraulic brake device).

Here, in the first embodiment, this movement of the additional operating member 46 is configured to perform a braking operation. When the additional operating member 46 is pivoted to the operated position (FIG. 11), the first operating member 42 and the second operating member 44 move with the additional operating member 46. However, the braking operation of the additional operating member 46 does not cause the electrical switch 52 to be actuated.

As seen in FIG. 12, the hydraulic unit 56 is integrated into the main body 32 of the base member 30. In particular, the hydraulic unit 56 includes a cylinder bore 58 formed in the main body 32 of the base member 30. The hydraulic unit 56 further comprises a piston 60. The piston 60 is movably disposed in the cylinder bore 58. The piston 60 moves linearly inside the cylinder bore 58 in response to a braking operation of the additional operating member 46. Thus, the additional operating member 46 is operatively coupled to the piston 60 to move the piston 60 within the cylinder bore 58. In particular, the hydraulic unit 56 further comprises an actuation part 62. The actuation part 62 is operatively coupled between the piston 60 and the additional operating member 46. The actuation part 62 has one end fixed to the additional operating member 46, and in sliding contact with a pair of rollers 64 that are coupled to the piston 60. In this way, the additional operating member 46 is connected to the piston 60 by the actuation part 62.

The hydraulic unit 56 further comprises a piston biasing element 66 that is mounted to the main body 32 of the base member 30. Specifically, the piston biasing element 66 biases the piston 60 to a non-actuated (rest or non-operated) position. Here, the piston biasing element 66 is a torsion spring that biases the piston 60 to the non-actuated or rest position. The piston biasing element 66 also biases the additional operating member 46 to its rest position (i.e., a state where no external force is applied to the additional operating member 46). In the first embodiment, the hydraulic unit 56 further comprises a hydraulic reservoir 68 that is connected to the cylinder bore 58. The hydraulic reservoir 68 is filled with a hydraulic fluid such as a mineral oil. The hydraulic reservoir 68 is disposed above the cylinder bore 58 where the first operating device 12 is in the mounted (installed) state. Since hydraulic units are well known, the hydraulic unit 56 will not be discussed in further detail for the sake of brevity.

Alternatively, the hydraulic unit 56 can be omitted and a conventional control cable can be attached to the additional operating member 46 for operating the third operated device 20 where the third operated device 20 is a mechanically operated brake device. Also, alternatively, the hydraulic unit 56 can be replaced with an electrical switch for operating the third operated device 20 where the third operated device 20 is an electrically operated brake device.

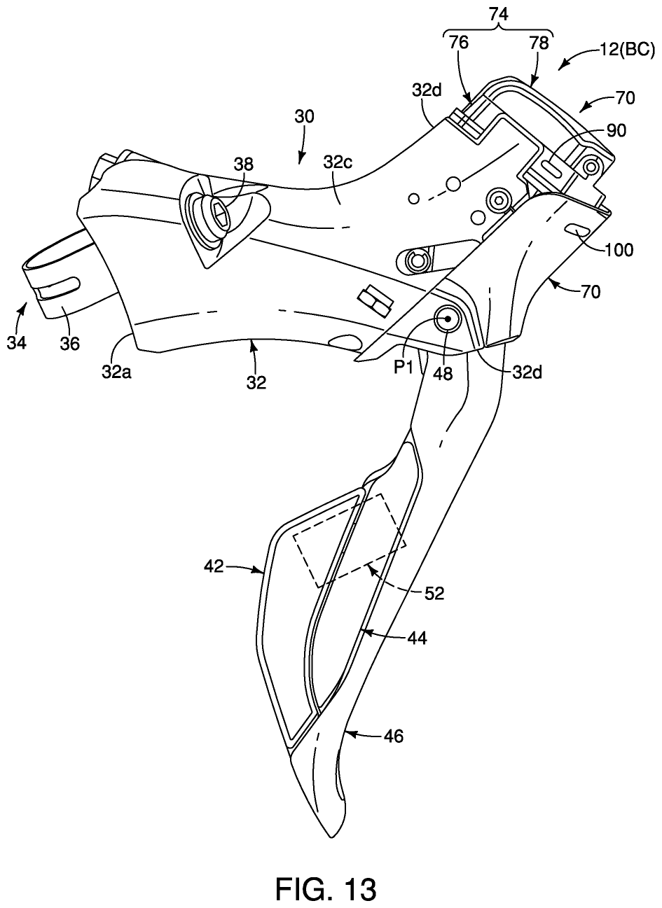

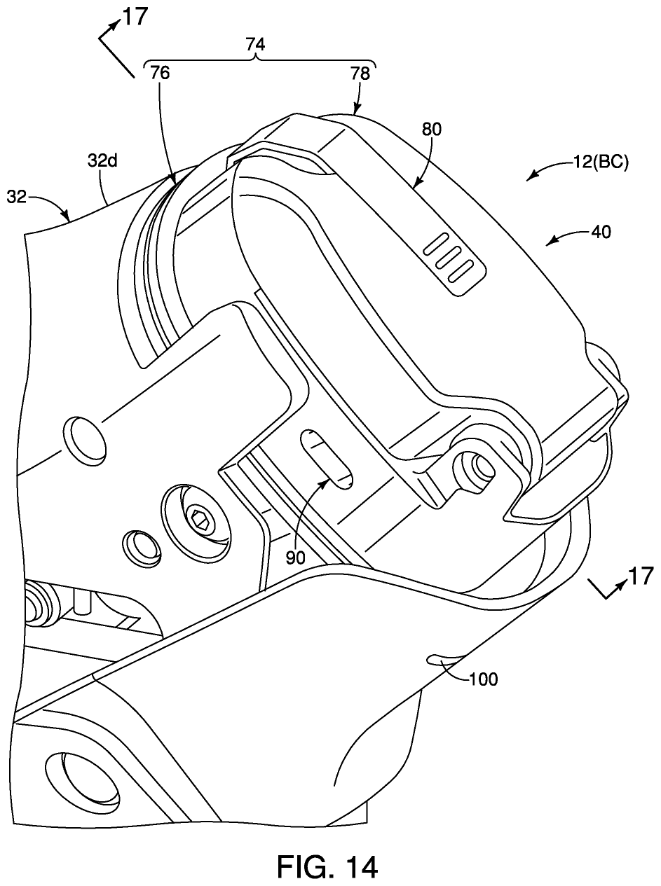

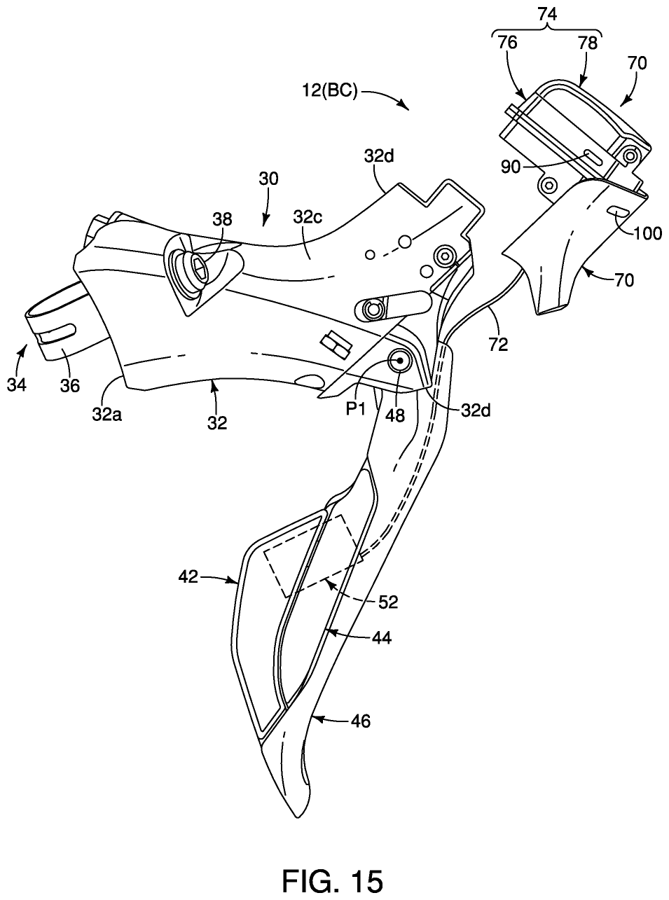

Referring now to FIGS. 13 to 18, in the first embodiment, the bicycle component BC (e.g., the first operating device 12) further comprises an electrical unit 70. Here, the electrical unit 70 forms a part of the pommel portion 32d of the main body 32. Basically, the electrical unit 70 is configured to supply electric power to the electrical switch 52 via an electrical cable 72, and to at least output control signals to the first operated device 16 (e.g., a rear derailleur). Here, the electrical unit 70 outputs control signals to the first operated device 16 (e.g., a rear derailleur), the second operated device 18 (e.g., a front derailleur), the cycle computer CC and the communication device CD.

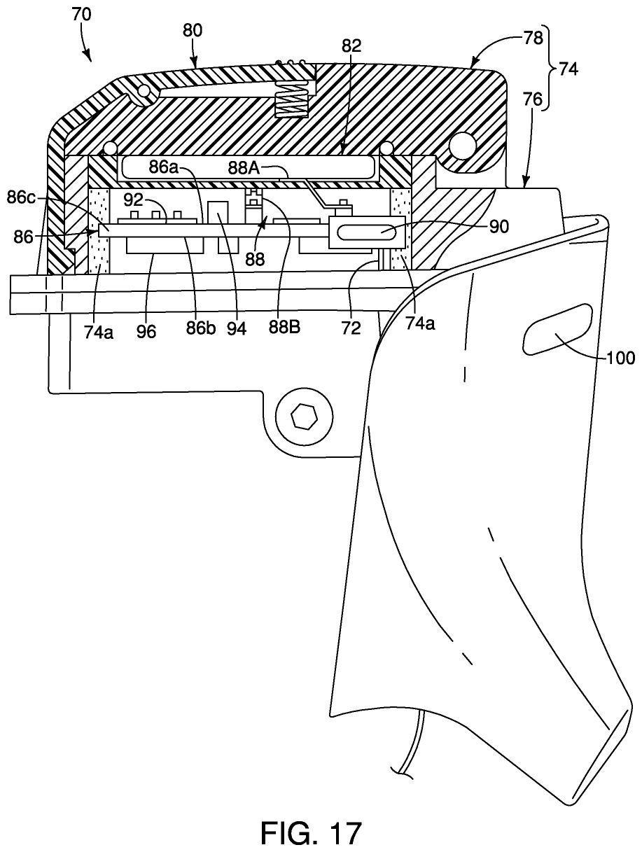

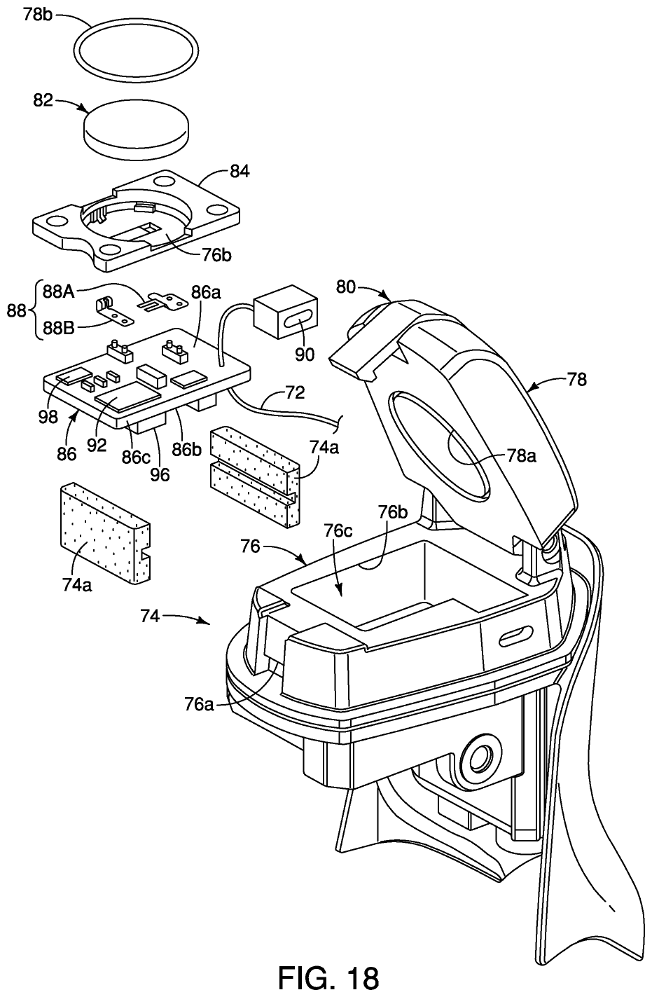

In the first embodiment, the electrical unit 70 includes a holding structure 74 for holding various electrical parts that are provided to the base member 30. Preferably, the holding structure 74 is detachably attached to the pommel portion 32d of the main body 32 by a pair of screws. Thus, the bicycle component BC (e.g., the first operating device 12) further comprises the holding structure 74. Here, the holding structure 74 includes an accommodating part 76 and a power source cover 78. As seen in FIGS. 17 and 18, the power source cover 78 is pivotally coupled to the accommodating part 76 for accessing the electrical parts provided in the holding structure 74 of the electrical unit 70. Here, the holding structure 74 includes a cover fixing structure 80. The cover fixing structure 80 is configured to fix the power source cover 78 relative to the accommodating part 76. For example, as illustrated, the cover fixing structure 80 can be a latch that is pivotally mounted to the power source cover 78 and configured to engage a catch surface 76a of the accommodating part 76. The power source cover 78 can be provided with various sealing structures for preventing contaminants from entering the holding structure 74 between the accommodating part 76 and the power source cover 78 as needed and/or desired. For example, the power source cover 78 have a recess 78a for receiving an elastomeric O-ring 78b.

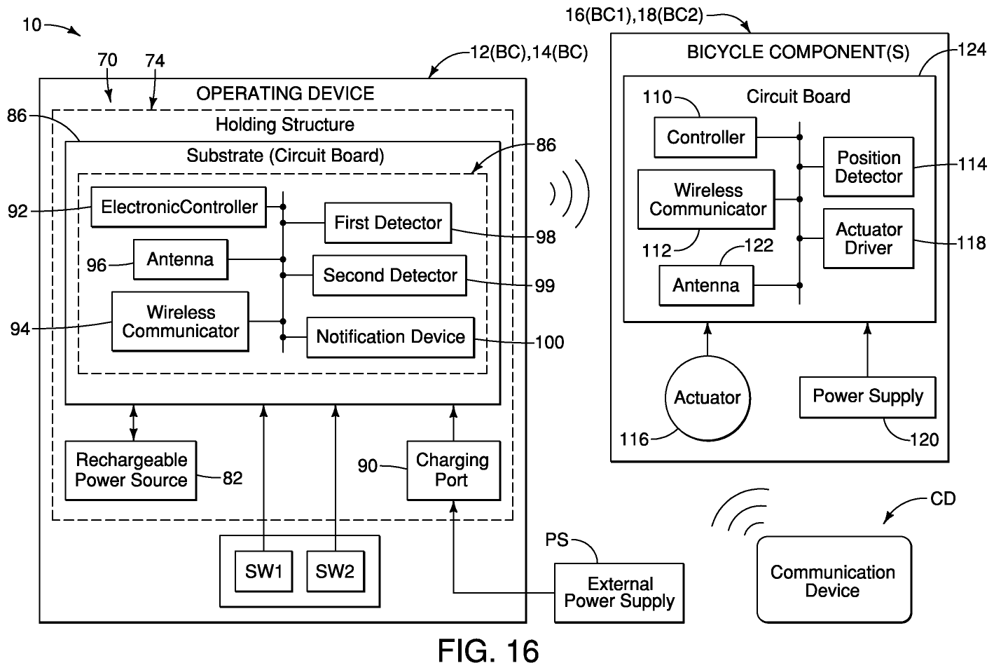

As seen in FIGS. 16 to 18, the bicycle component BC (e.g., the first operating device 12) further comprises a rechargeable power source 82. For example, the rechargeable power source 82 is a secondary battery. In the first embodiment, the rechargeable power source 82 includes at least one rechargeable coin battery. Alternatively, the rechargeable power source 82 can be a battery with a pluggable connector. Referring to FIG. 16, the rechargeable power source 82 is configured to be charged by electric power from an external power supply PS. Thus, the rechargeable power source 82 can be recharged as needed and/or desired.

The rechargeable power source 82 is configured to provide electric power to the electrical parts of the bicycle component BC (e.g., the first operating device 12). For example, the rechargeable power source 82 is configured to provide electric power to the electrical switch 52 via the electrical cable 72. To conserve power, as explained below, the rechargeable power source 82 is controlled to limit and/or stop the supply of electric power to the electrical switch 52 depending on an operating condition of the bicycle B or the bicycle component BC (e.g., the first operating device 12). In any case, the electrical switch 52 is configured to be activated by electric power from the rechargeable power source 82. In the first embodiment, the electrical switch 52 is configured to be activated by only electric power from the rechargeable power source 82. In one possible modification, the bicycle component BC (e.g., the first operating device 12) can include both a secondary battery and another battery (e.g., a primary battery) that can be used together to supply electric power to the electrical switch 52.

Here, the holding structure 74 is configured to removably hold the rechargeable power source 82. More specifically, the accommodating part 76 is configured to accommodate the rechargeable power source 82. The accommodating part 76 includes an opening 76b for removing the rechargeable power source 82 from the holding structure 74. In particular, in the first embodiment, the accommodating part 76 includes an accommodating space 76c for accommodating the rechargeable power source 82. Here, the accommodating space 76c is, for example, formed by a recess in an upper surface of the accommodating part 76. The opening 76b is formed by an upper edge of the accommodating space 76c. In the first embodiment, the rechargeable power source 82 is supported on a holder 84. Thus, the holder 84 supports the rechargeable power source 82 in the accommodating space 76c of the accommodating part 76.

Referring to FIGS. 17 and 18, the power source cover 78 is configured to at least partially cover the opening 76b of the accommodating part 76. Here, the power source cover 78 completely covers the opening 76b, and is configured to restrict movement of the rechargeable power source 82 in the accommodating space 76c of the accommodating part 76. Alternatively, the power source cover 78 can be omitted and the grip cover 40 can serve as the power source cover as needed and/or desired. In the case where the grip cover 40 functions as the power source cover, then no other part is needed to cover the rechargeable power source 82. In any case, the holding structure 74 is configured to detachably hold the rechargeable power source 82 to the bicycle component BC (e.g., the first operating device 12) in the first embodiment.

Also, the bicycle component BC (e.g., the first operating device 12) further comprises a substrate 86. The substrate 86 has a first side 86a, a second side 86b and a peripheral edge 86c. The second side 86b faces in an opposite direction to the first side 86a. The peripheral edge 86c is disposed between the first side 86a and the second side 86b. The substrate 86 is provided in the holding structure 74. Here, the holding structure 74 includes a pair of supports 74a for supporting the rechargeable power source 82 and the substrate 86 in the accommodating space 76c of the accommodating part 76. The substrate 86 is a circuit board that supports various components. In first embodiment, the substrate 86 is a printed circuit board that is configured to electrically connect components to one another in a circuit.

The rechargeable power source 82 is electrically connected to the substrate 86 to provide electric power to the components that are provided to the substrate 86 or components that are electrically connected to the substrate 86. Thus, the electrical switch 52 is configured to receive electric power from the rechargeable power source 82 via the electrical cable 72 and the substrate 86. More specifically, the holding structure 74 includes an electrical terminal structure 88. The electrical terminal structure 88 electrically couples the rechargeable power source 82 to the bicycle component BC (e.g., the first operating device 12). In particular, the electrical terminal structure 88 is provided to the substrate 86 such that the electrical terminal structure 88 is electrically coupled to the substrate 86. When the rechargeable power source 82 is installed in the holding structure 74, the rechargeable power source 82 is electrically coupled to the substrate 86 via the electrical terminal structure 88, and the electrical switch 52 is electrically coupled to the substrate 86 via the electrical cable 72. In this way, the rechargeable power source 82 is electrically coupled to the electrical switch 52 via the electrical cable 72 and the substrate 86. In the first embodiment, the electrical terminal structure 88 includes a first terminal 88A and a second terminal 88B. Here, the first terminal 88A and the second terminal 88B are electrical contacts that protrude from the substrate 86 for contacting the rechargeable power source 82. Alternatively, the first terminal 88A and the second terminal 88B can be provided in a pluggable connector that is configured to receive a mating pluggable connector of a rechargeable power source. Also, alternatively, the first terminal 88A and the second terminal 88B can be electrical contacts that are contacted by terminals protruding from a button type rechargeable battery.

As seen in FIGS. 16 to 18, the bicycle component BC (e.g., the first operating device 12) further comprises a charging port 90. The charging port 90 is electrically connected to the substrate 86. Thus, the charging port 90 is electrically connected to the rechargeable power source 82 via the substrate 86. In this way, the charging port 90 is configured to supply electrical power to the rechargeable power source 82 from the external power supply PS. In the first embodiment, the charging port 90 includes a USB Type connector. Alternatively, other types of electrical connectors can be used as needed and/or desired.

As seen in FIGS. 3, 10 and 11, the bicycle component BC (e.g., the first operating device 12) further comprises a cover member 40a configured to cover the charging port 90 in a case where the cover member 40a is in a covering state. In the first embodiment, the cover member 40a is a part of the grip cover 40. In particular, the cover member 40a is a flap that is hinged to the rest of the grip cover 40 by a living hinge. The cover member 40a covers a hole in the grip cover 40 and the opening of the charging port 90 in a case where the cover member 40a is in a covering state. Alternatively, the cover member 40a can be omitted such that the grip cover 40 forms the cover member for the charging port 90. In this modification, the grip cover 40 can be removed from the pommel portion 32d of the main body 32 to expose the opening of the charging port 90.

Referring to FIGS. 16 and 18, the bicycle component BC (e.g., the first operating device 12) further comprises an electronic controller 92. Basically, the electronic controller 92 includes at least one processor that is configured to execute predetermined control program (e.g., a pairing program, a shifting program, a power management program, etc.). The processor of the electronic controller 92 includes, for example, a central processing unit (CPU) or a micro processing unit (MPU). The electronic controller 92 is formed of one or more semiconductor chips that are mounted on the substrate 86. Thus, the terms “controller” and “electronic controller” as used herein refer to hardware that executes a software program, and does not include a human being. The electronic controller 92 is configured to receive electric power from the rechargeable power source 82 via the substrate 86. Preferably, the electronic controller 92 is configured to control the supply of electric power from the rechargeable power source 82 to the other electrical parts of the bicycle component BC (e.g., the first operating device 12). The electronic controller 92 is preferably connected to a data storage device provided to the electrical unit 70. For example, a data storage device can be provided on the substrate 86. The data storage device can be any non-transitory computer readable medium such as a ROM (Read Only Memory) device, a RAM (Random Access Memory) device, a hard disk, a flash drive, etc. Here, for example, the data storage device includes, for example, at least one of a read-only memory (ROM), an erasable programmable read only memory (EPROM), an electrically erasable programmable read-only memory (EEPROM), and a flash memory. The data storage device stores various control processes or control programs, as well as information or data used by the electronic controller 92.

The bicycle component BC (e.g., the first operating device 12) further comprises a wireless communicator 94. The wireless communicator 94 can be either a one-way wireless communicator (i.e., a wireless transmitter) or a two-way wireless communicator (i.e., a wireless transceiver) as needed and/or desired. For example, in the first embodiment, the wireless communicator 94 includes a signal transmitting circuit (TX circuit) and a signal receiving circuit (RX circuit) so that the wireless communicator 94 is configured to both receive and transmit wireless communication signals, or just a signal transmitting circuit (TX circuit).

The substrate 86 supports the wireless communicator 94. In particular, in the first embodiment, the wireless communicator 94 is electrically connected to the electronic controller 92 via the substrate 86. The electronic controller 92 is configured to control the wireless communicator 94. Alternatively, the wireless communicator 94 can be provided with its own electronic controller as needed and/or desired. Also, the wireless communicator 94 is electrically coupled to the rechargeable power source 82. Here, the wireless communicator 94 is configured to receive electric power from the rechargeable power source 82 via the substrate 86. Preferably, the electronic controller 92 is configured to control the supply of electric power from the rechargeable power source 82 to the wireless communicator 94.

The bicycle component BC (e.g., the first operating device 12) further comprises an antenna 96. The antenna 96 is configured to receive and transmit wireless signals from the wireless communicator 94. The antenna 96 is provided to the substrate 86 and electrically coupled to the wireless communicator 94. A signal amplifier can be provided to the substrate 86 for selectively amplifying the signals of the antenna 96 as needed and/or desired. The substrate 86 is disposed between the rechargeable power source 82 and the antenna 96. In particular, in the first embodiment, the substrate 86 supports the wireless communicator 94 on the first side 86a. The antenna 96 is provided to the second side 86b of the substrate 86, and is electrically coupled to the wireless communicator 94. The rechargeable power source 82 is closer to the power source cover 78 than the antenna 96.

The electronic controller 92 is configured to control supply of electrical power from the rechargeable power source 82 to the wireless communicator 94 based on an output from a detector 98. The detector 98 is configured to detect a state of at least one of the bicycle B and the bicycle component BC (e.g., the first operating device 12). For example, the detector 98 is a wake up detector that is configured to detect a vibration, and/or a movement of the bicycle B or the bicycle component BC that is indicative of the bicycle B and/or the bicycle component BC being used. The detector 98 can be referred to as a first detector, or as a wake up detector. As shown in FIG. 16, in the first embodiment, the wake up detector 98 is provided on the substrate 86. However, the location of the wake up detector 98 is not limited to the illustrated location. Here, the wake up detector 98 can be an acceleration sensor that detects a vibration, and/or a movement of the bicycle B or the bicycle component BC that is indicative of the bicycle B and/or the bicycle component BC being used.

As shown in FIG. 16, in the first embodiment, a second detector 99 is provided in the electrical unit 70. The second detector 99 is configured to measure at least one of voltage, current, temperature, and other properties of the rechargeable power source 82. The second detector 99 can be referred to as a SOC detector. The electronic controller 92 is configured to determine a current state of charge of the rechargeable power source 82 from the detected values of the second detector 99. Here, the substrate 86 is further provided with the second detector 99. However, the location of the second detector 99 is not limited to the illustrated location.

The electronic controller 92 is configured to obtain information related to the rechargeable power source 82. For example, the electronic controller 92 is configured to obtain a current power level or state of charge (SOC) of the rechargeable power source 82 from the second detector 99. Also, for example, the electronic controller 92 is configured to obtain a battery life (e.g., a number of charge and discharge cycles that can be completed before losing performance) of the rechargeable power source 82 from the second detector 99. The wireless communicator 94 is configured to transmit the information related to the rechargeable power source 82 to an external device. For example, the wireless communicator 94 is configured to transmit a current power level or state of charge (SOC) of the rechargeable power source 82 to the external device (e.g., the communication device CD or the cycle computer CC). Also, for example, the wireless communicator 94 is configured to transmit a battery life (e.g., a number of charge and discharge cycles that can be completed before losing performance) to the external device (e.g., the communication device CD or the cycle computer CC).

As shown in FIG. 16, in the first embodiment, the bicycle component BC (e.g., the first operating device 12) further comprises a notification device 100 electrically coupled to the electronic controller 92. Here, for example, the notification device 100 includes an LED circuit and a light transmission member that is configured to transmit light emitted from the LEDs of the LED circuit. Here, the LED circuit of the notification device 100 is provided on the second side 86b of the substrate 86. However, the notification device 100 can be provided at a location remote from the substrate 86. The light transmission member of the notification device 100 extends from a position adjacent to the LEDs of the LED circuit to a window portion formed in the exterior of the electrical unit 70. The electronic controller 92 is configured to control the notification device 100 based on the information. For example. the LED circuit of the notification device 100 is controlled by the electronic controller 92 such that one or more LEDs are illuminated to produce a desired notification (e.g., blue light, a red light, a green light, a steady state light, a flashing light, etc.) to indicate the information that was determined based on the second detector 99.

Referring back to FIG. 16, the electrical configurations of the first operated device 16 (e.g., a rear derailleur) and the second operated device 18 (e.g., a front derailleur) will now be discussed. For example, the first operated device 16 (e.g., a rear derailleur) and the second operated device 18 (e.g., a front derailleur) each includes an electronic controller 110 and a wireless communicator 112. Also, the first operated device 16 (e.g., a rear derailleur) and the second operated device 18 (e.g., a front derailleur) each preferably includes a position detector 114, an actuator 116, an actuator driver 118, a power supply 120 and an antenna 122. Here, the electronic controller 110, the wireless communicator 112, the position detector 114 and the antenna 122 are provided to a circuit board 124. However, it will be apparent from this disclosure that the electronic controller 110, the wireless communicator 112, the position detector 114 and the antenna 122 can be provided at different locations to different circuit boards.

Also, while the first operated device 16 (e.g., a rear derailleur) and the second operated device 18 (e.g., a front derailleur) are illustrated with their own individual power supply, the first operated device 16 (e.g., a rear derailleur) and the second operated device 18 (e.g., a front derailleur) can share a power supply that is provided to one of the bicycle components BC or remotely located on the frame F of the bicycle B.

The wireless communicator 112 receives wireless control signals transmitted from the wireless communicator 84 of the first operating device 12 or the second operating device 14. The wireless control signals are processed by the electronic controller 110, which controls the actuator 116 via the actuator driver 118. Thus, the actuator driver 118 control the actuator 116 based on the control signal of the electronic controller 110.

Examples of the actuator 116 include a direct-current (DC) motor and a stepper motor. In the case where the first operated device 16 and the second operated device 18 are external transmission devices (e.g., derailleurs), the first operated device 16 and the second operated device 18 are provided a chain guide, and the actuator 116 is operatively coupled to the chain guide more moving the chain guide. The position detector 114 is configured to sense a current gear position of the rear derailleur 14. Examples of the position detector 114 include a potentiometer and a rotary encoder. The position detector 114 is configured to sense an absolute rotational position of a rotational shaft of the actuator 116 as the current gear position of the gear rear derailleur 14. The actuator 116 and the position detector 114 are electrically connected to the actuator driver 118.

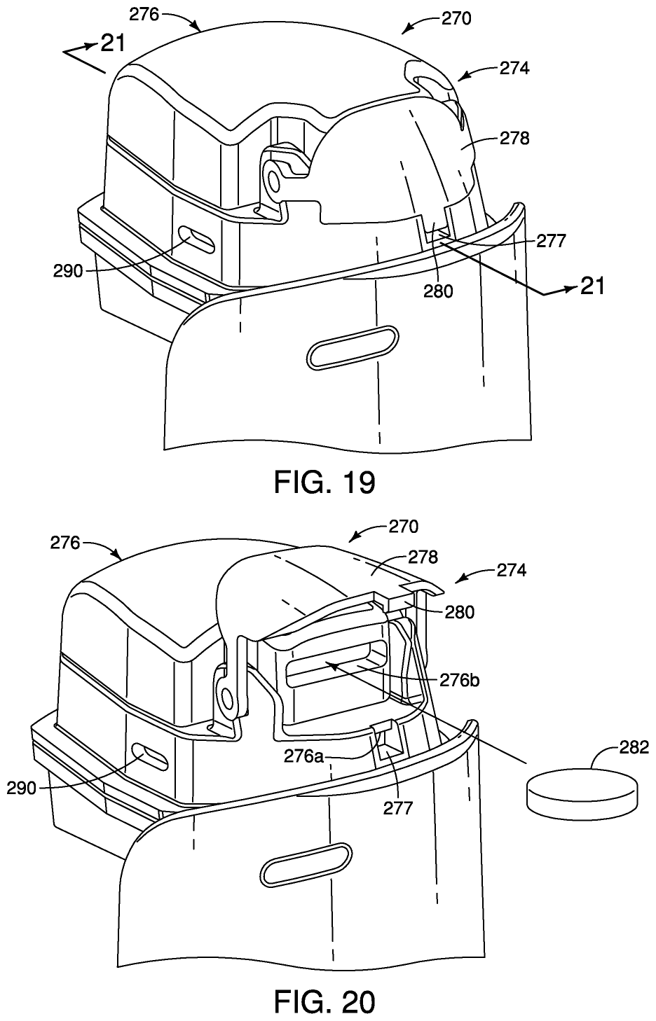

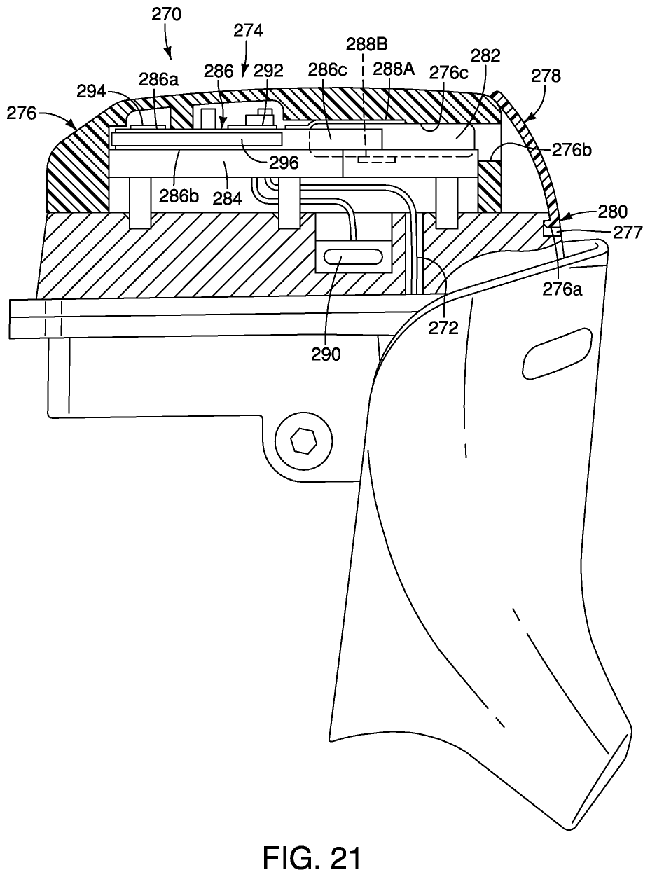

Referring now to FIGS. 19 to 22, an electrical unit 270 is illustrated in accordance with a second embodiment. The electrical unit 270 is configured to be used with the base member 30 of the first embodiment. Thus, the electrical unit 270 is configured to be electrically connected to the electrical switch 52 via an electrical cable 272. The electrical unit 270 is functionally identical to the electrical unit 70. The electrical unit 270 is an alternate configuration of the parts from the configuration of the parts of the electrical unit 70. In view of the functional similarity between the first embodiment and the second embodiment, the following the descriptions of the second embodiment will focus on the differences in the configuration of the electrical unit 270 from the configuration of the electrical unit 70.

Basically, the electrical unit 270 includes a holding structure 274 for holding various electrical parts that are provided to the base member 30. Preferably, the holding structure 274 is detachably attached to the pommel portion 32d of the main body 32 by a pair of screws in the same manner as the first embodiment.

In the second embodiment, as seen in FIGS. 19 to 22, the holding structure 274 includes an accommodating part 276 and a power source cover 278. Here, the accommodating part 276 includes an upper portion and a lower portion that are snap-fitted together. The power source cover 278 is pivotally coupled to the upper portion of the accommodating part 276. Here, the holding structure 274 includes a cover fixing structure 280. For example, as illustrated, the cover fixing structure 280 can be a latch that is provided to the power source cover 278 and configured to engage a catch surface 276a of the lower portion of the accommodating part 276. Preferably, the catch surface 276a is formed by a notch 277 in the accommodating part 276. The notch 277 is sized to receive a tool such as a screwdriver for disengaging the cover fixing structure 280 (e.g., the latch) from the catch 276a.

The electrical unit 270 further comprises a rechargeable power source 282. For example, the rechargeable power source 282 is a secondary battery. In the second embodiment, the rechargeable power source 282 includes at least one rechargeable coin battery. Alternatively, the rechargeable power source 282 can be a battery with a pluggable connector. The rechargeable power source 282 is configured to provide electric power to the electrical parts of the electrical unit 270 and the electrical switch 52 where the electrical unit 270 is installed to the base member 30. Thus, the electrical switch 52 is configured to be activated by electric power from the rechargeable power source 282 where the electrical unit 270 is installed to the base member 30. In the second embodiment, the electrical switch 52 is configured to be activated by only electric power from the rechargeable power source 282.

In the second embodiment, the holding structure 274 is configured to removably hold the rechargeable power source 282. More specifically, the accommodating part 276 is configured to accommodate the rechargeable power source 282. The accommodating part 276 includes an opening 276b for removing the rechargeable power source 282 from the holding structure 274. The opening 276b is in an upper portion of the accommodating part 276. Also, in the second embodiment, the accommodating part 276 includes an accommodating space 276c for accommodating the rechargeable power source 282 after the rechargeable power source 282 has been inserted through the opening 276b. In the second embodiment, the rechargeable power source 282 is supported on a holder 284 provided in the accommodating space 276c of the accommodating part 276. Thus, the holder 284 supports the rechargeable power source 282 in the accommodating space 276c of the accommodating part 276 so that the rechargeable power source 282 rests on the holder 284 after the rechargeable power source 282 has been inserted through the opening 276b. Preferably, the holding structure 274 includes a battery removal aid such as a battery removal ribbon to aid in the removal of the rechargeable power source 282. For example, one end of the battery removal ribbon is attached to the holder 284 and the battery removal ribbon wraps around the end of the battery opposite to the opening 276b so that a user can pull battery removal ribbon to pop the rechargeable power source 282 out through the opening 276b.

The electrical unit 270 further comprises a substrate 286. The substrate 286 has a first side 286a, a second side 286b and a peripheral edge 286c. The second side 286b faces in an opposite direction to the first side 286a. The peripheral edge 286c is disposed between the first side 286a and the second side 286b. The substrate 286 is provided in the holding structure 274. In particular, the substrate 286 is provided on the upper surface of the holder 284 in the accommodating space 276c of the accommodating part 276. The holder 284 supports the substrate 286 in the accommodating space 276c of the accommodating part 276. The substrate 286 is a circuit board that supports various components. In the second embodiment, the substrate 286 is a printed circuit board that is configured to electrically connect components to one another in a circuit.

The rechargeable power source 282 is electrically connected to the substrate 286 to provide electric power to the components that are provided to the substrate 286 or components that are electrically connected to the substrate 286. More specifically, the holding structure 274 includes an electrical terminal structure 288 that is provided to the substrate 286. The electrical terminal structure 288 contacts the rechargeable power source 282 to electrically couple the rechargeable power source 282 to the substrate 286. Thus, the electrical switch 52 is configured to receive electric power from the rechargeable power source 282 via the electrical cable 272 and the substrate 286.

In the second embodiment, the electrical terminal structure 288 includes a first or terminal 288A and a second terminal 288B. Here, the first terminal 288A and the second terminal 288B are electrical contacts that protrude from the substrate 286 for contacting the rechargeable power source 282. Alternatively, the first terminal 288A and the second terminal 288B can be provided in a pluggable connector that is configured to receive a mating pluggable connector of a rechargeable power source. Also, alternatively, the first terminal 288A and the second terminal 288B can be electrical contacts that are contacted by terminals protruding from a button type rechargeable battery.

The electrical unit 270 further comprises a charging port 290. The charging port 290 is electrically connected to the substrate 286. Thus, the charging port 290 is electrically connected to the rechargeable power source 282 via the substrate 286. In this way, similar to the first embodiment, the charging port 290 is configured to supply electrical power to the rechargeable power source 282 from an external power supply. In the second embodiment, the charging port 290 includes a USB Type connector. Alternatively, other types of electrical connectors can be used as needed and/or desired.

The electrical unit 270 further comprises an electronic controller 292. Basically, the electronic controller 292 includes at least one processor that is configured to execute predetermined control program (e.g., a pairing program, a shifting program, a power management program, etc.). The processor of the electronic controller 292 includes, for example, a central processing unit (CPU) or a micro processing unit (MPU). The electronic controller 292 is formed of one or more semiconductor chips that are mounted on the substrate 286. The electronic controller 292 has the same configuration of the electronic controller 92, which is discussed above, and thus, the electronic controller 292 will not be discussed in further detail.

The electrical unit 270 further comprises a wireless communicator 294. The wireless communicator 294 can be either a one-way wireless communicator (i.e., a wireless transmitter) or a two-way wireless communicator (i.e., a wireless transceiver) as needed and/or desired. The wireless communicator 294 has the same configuration of the wireless communicator 94, which is discussed above, and thus, the wireless communicator 294 will not be discussed in further detail. Here, the substrate 286 supports the wireless communicator 294, and electrically connects the wireless communicator 294 to the electronic controller 292 via the substrate 286. Alternatively, the wireless communicator 294 can be provided with its own electronic controller as needed and/or desired. The wireless communicator 294 is configured to receive electric power from the rechargeable power source 282 via the substrate 286. Preferably, the electronic controller 292 is configured to control the supply of electric power from the rechargeable power source 282 to the wireless communicator 294.

The electrical unit 270 further comprises an antenna 296. The antenna 296 is configured to receive and transmit wireless signals from the wireless communicator 294. The antenna 296 is provided to the substrate 286 and electrically coupled to the wireless communicator 294. In the second embodiment, the antenna 296 is disposed along a peripheral edge 286c of the substrate 286. A signal amplifier can be provided to the substrate 286 for selectively amplifying the signals of the antenna 296 as needed and/or desired. The substrate 286 is disposed between the rechargeable power source 282 and the antenna 296.

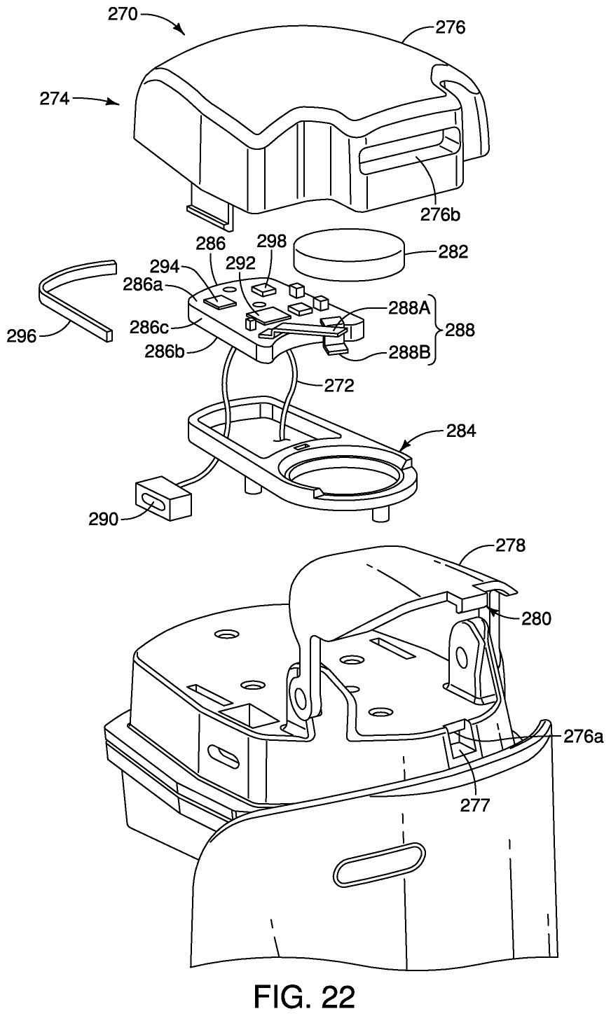

The electronic controller 292 is configured to control supply of electrical power from the rechargeable power source 282 to the wireless communicator 294 based on an output from a detector 298. The detector 298 is configured to detect a state of at least one of the bicycle B and the bicycle component BC (e.g., the first operating device 12). For example, the detector 298 is a wake up detector that is configured to detect a vibration, and/or a movement of the bicycle B or the bicycle component BC that is indicative of the bicycle B and/or the bicycle component BC being used. As shown in FIG. 22, in the second embodiment, the wake up detector 298 is provided on the substrate 286. However, the location of the wake up detector 298 is not limited to the illustrated location. Here, the wake up detector 298 can be an acceleration sensor that detects a vibration, and/or a movement of the bicycle B or the bicycle component BC that is indicative of the bicycle B and/or the bicycle component BC being used.

The electrical unit 270 also further comprises a SOC detector and a notification device similar to the SOC detector and a notification device of the electrical unit 70. In the second embodiment, the SOC detector and the notification device are identical to the second (SOC) detector 99 and the notification device 100, which are discussed above, and thus, the SOC detector and the notification device of the electrical unit 270 will not be further discussed.

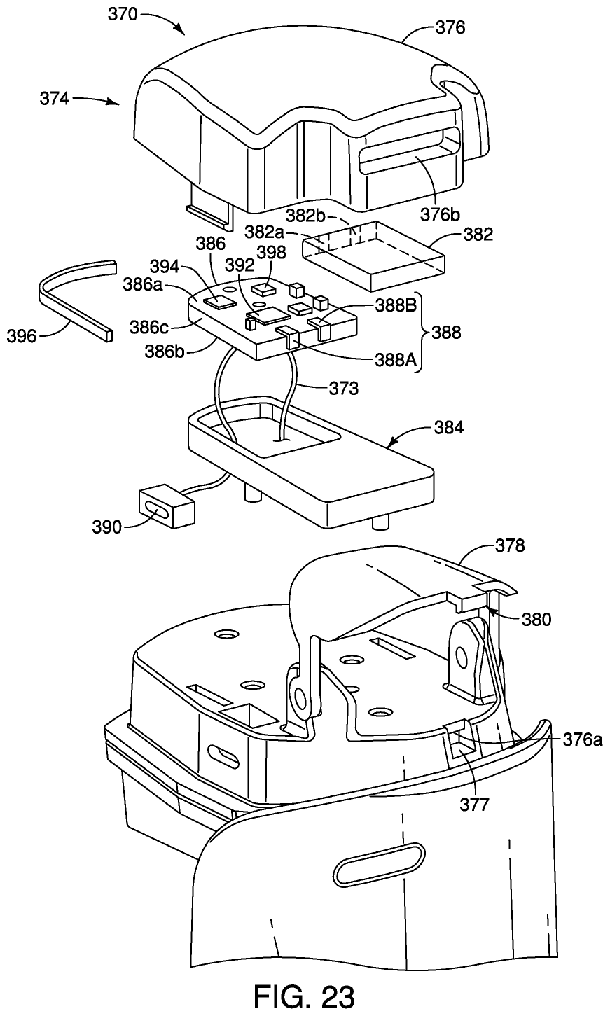

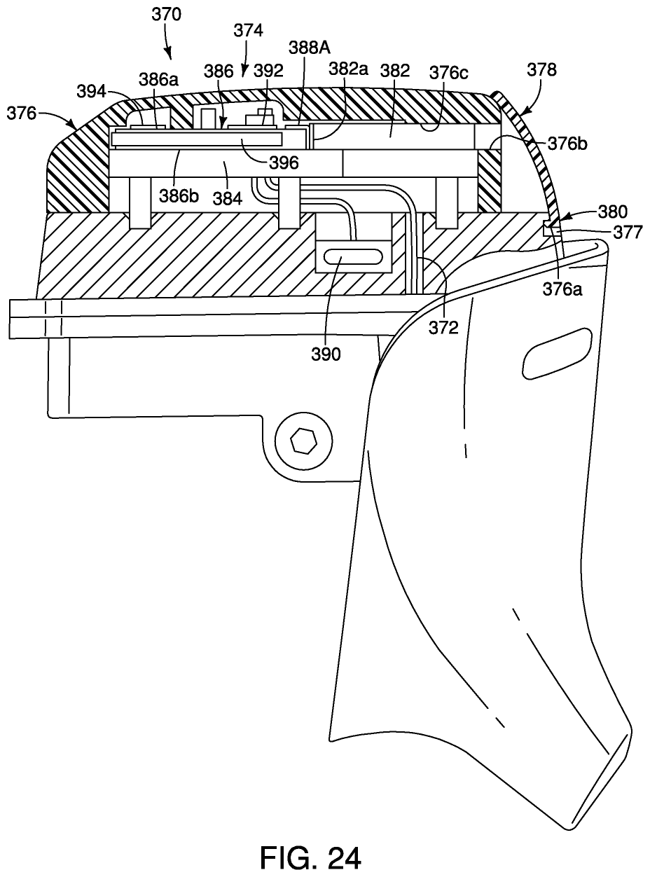

Referring now to FIGS. 23 and 24, an electrical unit 370 is illustrated in accordance with a third embodiment. The electrical unit 370 is configured to be used with the base member 30 of the first embodiment. Thus, the electrical unit 370 is configured to be electrically connected to the electrical switch 52 via an electrical cable 372. The electrical unit 370 is functionally identical to the electrical unit 70. The electrical unit 370 is an alternate configuration of the parts from the configuration of the parts of the electrical unit 70. In view of the functional similarity between the third embodiment and the prior embodiments, the following the descriptions of the third embodiment will focus on the differences in the configuration of the electrical unit 370 from the configuration of the electrical unit 70.

Basically, the electrical unit 370 includes a holding structure 374 for holding various electrical parts that are provided to the base member 30. Preferably, the holding structure 374 is detachably attached to the pommel portion 32d of the main body 32 by a pair of screws in the same manner as the first embodiment. The holding structure 374 is basically the same as the second embodiment. The holding structure 374 includes an accommodating part 376 and a power source cover 378. The power source cover 378 is pivotally coupled to the upper portion of the accommodating part 376. Here, the holding structure 374 includes a cover fixing structure 380. For example, as illustrated, the cover fixing structure 380 can be a latch that is provided to the power source cover 378 and configured to engage a catch surface 376a of the lower portion of the accommodating part 376. Preferably, the catch surface 376a is formed by a notch 377 in the accommodating part 376. The notch 377 is sized to receive a tool such as a screwdriver for disengaging the cover fixing structure 380 (e.g., the latch) from the catch 376a.

The holding structure 374 is configured to removably hold the rechargeable power source 382 similar to the second embodiment. The accommodating part 376 includes an opening 376b for removing the rechargeable power source 382 from the holding structure 374. The opening 376b is in an upper portion of the accommodating part 376. Also, the accommodating part 376 includes an accommodating space 376c for accommodating the rechargeable power source 382 after the rechargeable power source 382 has been inserted through the opening 376b. In the third embodiment, the rechargeable power source 382 is supported on a holder 384 so that the rechargeable power source 382 rests on the holder 384 after the rechargeable power source 382 has been inserted through the opening 376b.

The electrical unit 370 further comprises a substrate 386 having a first side 386a, a second side 386b and a peripheral edge 386c. The substrate 386 is provided in the holding structure 374. In particular, the substrate 386 is provided on the upper surface of the holder 384 in the accommodating space 376c of the accommodating part 376. The holder 384 supports the substrate 386 in the accommodating space 376c of the accommodating part 376. The substrate 386 is a circuit board that supports various components. Here, the substrate 386 is a printed circuit board that is configured to electrically connect components to one another in a circuit.

Here, the rechargeable power source 382 is a rectangular battery that is pushed through the opening 376b into the accommodating part 376. Preferably, a latch is provided in the accommodating part 376 to prevent movement of the rechargeable power source 382 in the accommodating space 376c of the accommodating part 376. The rechargeable power source 382 is electrically connected to the substrate 386 to provide electric power to the components that are provided to the substrate 386 or components that are electrically connected to the substrate 386. More specifically, the holding structure 374 includes an electrical terminal structure 388 that is provided to the substrate 386. The electrical terminal structure 388 contacts electrical contacts 382a and 382b of the rechargeable power source 382 to electrically couple the rechargeable power source 382 to the substrate 386. Thus, the electrical switch 52 is configured to receive electric power from the rechargeable power source 382 via the electrical cable 372 and the substrate 386.

In the third embodiment, the electrical terminal structure 388 includes a first or terminal 388A and a second terminal 388B. Here, the first terminal 388A and the second terminal 388B are electrical contacts that extend along the peripheral edge 386c of the substrate 386 for contacting the electrical contacts 382a and 382b of the rechargeable power source 382.

The electrical unit 370 further comprises a charging port 390. The charging port 390 is electrically connected to the substrate 386. Thus, the charging port 390 is electrically connected to the rechargeable power source 382 via the substrate 386. In this way, similar to the first embodiment, the charging port 390 is configured to supply electrical power to the rechargeable power source 382 from an external power supply.

The electrical unit 370 further comprises an electronic controller 392. Basically, the electronic controller 392 includes at least one processor that is configured to execute predetermined control program (e.g., a pairing program, a shifting program, a power management program, etc.). The processor of the electronic controller 392 includes, for example, a central processing unit (CPU) or a micro processing unit (MPU). The electronic controller 392 is formed of one or more semiconductor chips that are mounted on the substrate 386. The electronic controller 392 has the same configuration of the electronic controller 92, which is discussed above, and thus, the electronic controller 392 will not be discussed in further detail.

The electrical unit 370 further comprises a wireless communicator 394. The wireless communicator 394 can be either a one-way wireless communicator (i.e., a wireless transmitter) or a two-way wireless communicator (i.e., a wireless transceiver) as needed and/or desired. The wireless communicator 394 has the same configuration of the wireless communicator 94, which is discussed above, and thus, the wireless communicator 394 will not be discussed in further detail. Here, the substrate 386 supports the wireless communicator 394, and electrically connects the wireless communicator 394 to the electronic controller 392 via the substrate 386. The wireless communicator 394 is configured to receive electric power from the rechargeable power source 382 via the substrate 386. Preferably, the electronic controller 392 is configured to control the supply of electric power from the rechargeable power source 382 to the wireless communicator 394.

The electrical unit 370 further comprises an antenna 396. The antenna 396 is configured to receive and transmit wireless signals from the wireless communicator 394. The antenna 396 is provided to the substrate 386 and electrically coupled to the wireless communicator 394. Here, the antenna 396 is disposed along a peripheral edge 386c of the substrate 386. A signal amplifier can be provided to the substrate 386 for selectively amplifying the signals of the antenna 396 as needed and/or desired.

The electronic controller 392 is configured to control supply of electrical power from the rechargeable power source 382 to the wireless communicator 394 based on an output from a detector 398. The detector 398 is configured to detect a state of at least one of the bicycle B and the bicycle component BC (e.g., the first operating device 12). For example, the detector 398 is a wake up detector that is configured to detect a vibration, and/or a movement of the bicycle B or the bicycle component BC that is indicative of the bicycle B and/or the bicycle component BC being used. Here, in the third embodiment, the wake up detector 398 is provided on the substrate 386. The electrical unit 370 also further comprises a SOC detector and a notification device similar to the SOC detector and a notification device of the electrical unit 70.

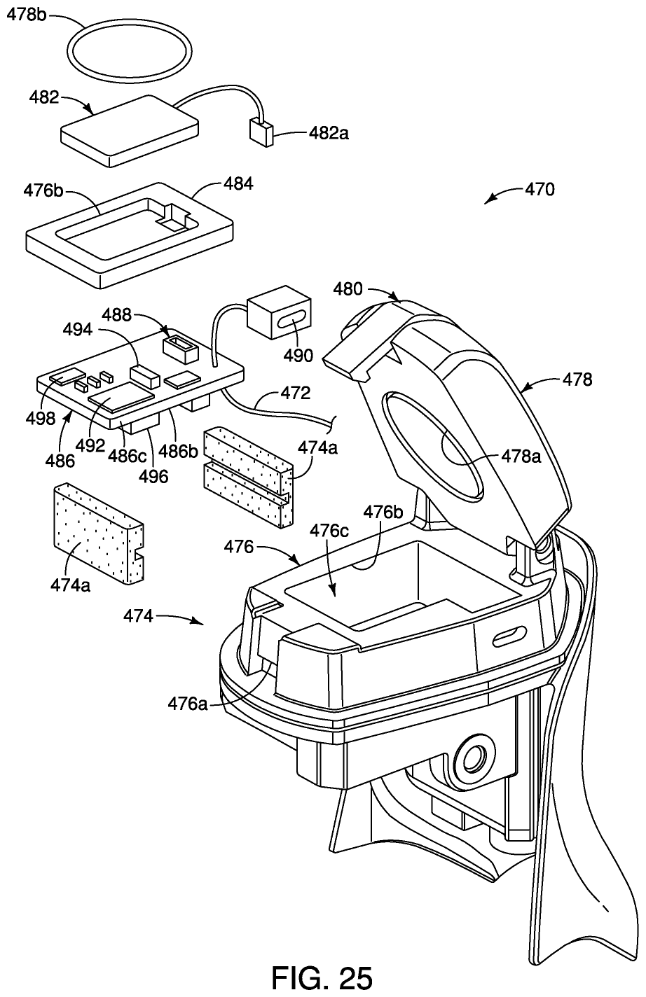

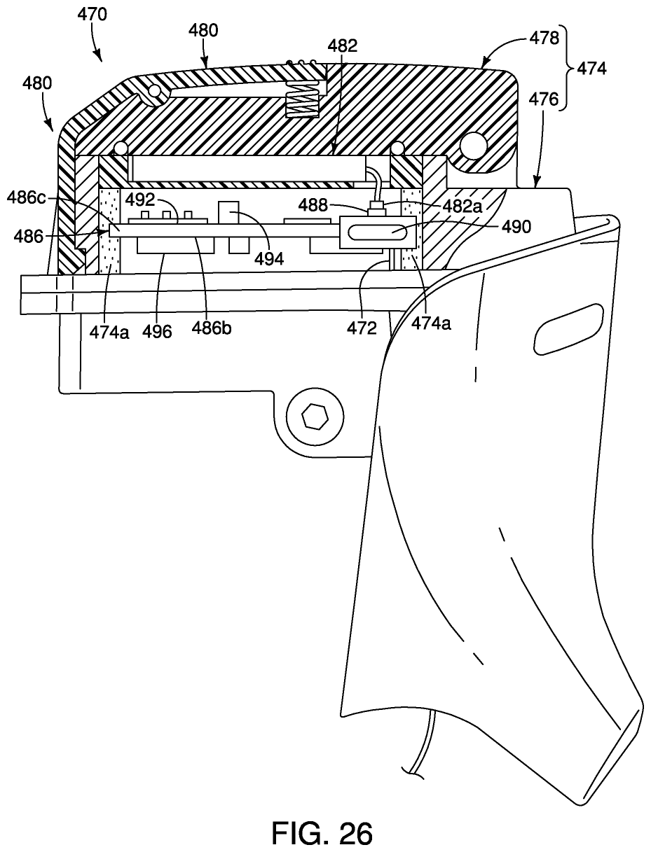

Referring now to FIGS. 25 and 26, an electrical unit 470 is illustrated in accordance with a fourth embodiment. The electrical unit 470 is configured to be used with the base member 30 of the first embodiment. Thus, the electrical unit 470 is configured to be electrically connected to the electrical switch 52 via an electrical cable 472. The electrical unit 70 is functionally identical to the electrical unit 70. The electrical unit 470 is an alternate configuration of the parts from the configuration of the parts of the electrical unit 70. In view of the functional similarity between the fourth embodiment and the prior embodiments, the following the descriptions of the fourth embodiment will focus on the differences in the configuration of the electrical unit 470 from the configuration of the electrical unit 70.

Basically, the electrical unit 470 includes a holding structure 474 for holding various electrical parts that are provided to the base member 30. Preferably, the holding structure 474 is detachably attached to the pommel portion 32d of the main body 32 by a pair of screws in the same manner as the first embodiment. The holding structure 474 is basically the same as the first embodiment. The holding structure 474 includes an accommodating part 476 and a power source cover 478. The power source cover 478 is pivotally coupled to the upper portion of the accommodating part 476. Here, the holding structure 474 includes a cover fixing structure 480. For example, as illustrated, the cover fixing structure 480 can be a latch that is provided to the power source cover 478 and configured to engage a catch surface 476a of the accommodating part 476.

The holding structure 474 is configured to removably hold the rechargeable power source 482 similar to the first embodiment. The accommodating part 476 includes an opening 476b for removing the rechargeable power source 482 from the holding structure 474. The opening 476b is in an upper portion of the accommodating part 476. Also, the accommodating part 476 includes an accommodating space 476c for accommodating the rechargeable power source 482 after the rechargeable power source 482 has been inserted through the opening 476b. In the fourth embodiment, the rechargeable power source 482 is supported on a holder 484 provided in the accommodating space 476c of the accommodating part 476.

The electrical unit 470 further comprises a substrate 486 having a first side 486a, a second side 486b and a peripheral edge 486c. The substrate 486 is provided in the holding structure 474. In particular, the substrate 486 is provided on the upper surface of the holder 484 in the accommodating space 476c of the accommodating part 476. The holder 484 supports the substrate 486 in the accommodating space 476c of the accommodating part 476. The substrate 486 is provided in the holding structure 474. Here, the holding structure 474 includes a pair of supports 474a for supporting the rechargeable power source 482 and the substrate 486 in the accommodating space 476c of the accommodating part 476. The substrate 486 is a circuit board that supports various components. Here, the substrate 486 is a printed circuit board that is configured to electrically connect components to one another in a circuit.

Here, the rechargeable power source 482 is a rectangular battery that is provided with a pluggable electrical connector 482a. The rechargeable power source 482 is electrically connected to the substrate 486 to provide electric power to the components that are provided to the substrate 486 or components that are electrically connected to the substrate 486. More specifically, the holding structure 474 includes an electrical terminal structure 488 that is provided to the substrate 486. The electrical terminal structure 488 contacts the rechargeable power source 482 to electrically couple the rechargeable power source 482 to the substrate 486. Thus, the electrical switch 52 is configured to receive electric power from the rechargeable power source 482 via the electrical cable 472 and the substrate 486.

In the fourth embodiment, the electrical terminal structure 488 is a pluggable electrical connector that is mounted on the first side 486a of the substrate 486. Here, the pluggable electrical connector 482a of the rechargeable power source 482 is configured to mate with the electrical terminal structure 488 for electrically connecting the rechargeable power source 482 to the circuitry of the substrate 486. In other words, the pluggable electrical connector 482a of the rechargeable power source 482 is pushed into connection with the pluggable electrical connector of the electrical terminal structure 488. For example, the pluggable electrical connector 482a of the rechargeable power source 482 is a male electrical connector and the pluggable electrical connector of the electrical terminal structure 488 is a female electrical connector.

The electrical unit 470 further comprises a charging port 490. The charging port 490 is electrically connected to the substrate 486. Thus, the charging port 490 is electrically connected to the rechargeable power source 482 via the substrate 486. In this way, similar to the first embodiment, the charging port 490 is configured to supply electrical power to the rechargeable power source 482 from an external power supply.

The electrical unit 470 further comprises an electronic controller 492. Basically, the electronic controller 492 includes at least one processor that is configured to execute predetermined control program (e.g., a pairing program, a shifting program, a power management program, etc.). The processor of the electronic controller 492 includes, for example, a central processing unit (CPU) or a micro processing unit (MPU). The electronic controller 492 is formed of one or more semiconductor chips that are mounted on the substrate 486. The electronic controller 492 has the same configuration of the electronic controller 92, which is discussed above, and thus, the electronic controller 492 will not be discussed in further detail.

The electrical unit 470 further comprises a wireless communicator 494. The wireless communicator 494 can be either a one-way wireless communicator (i.e., a wireless transmitter) or a two-way wireless communicator (i.e., a wireless transceiver) as needed and/or desired. The wireless communicator 494 has the same configuration of the wireless communicator 94, which is discussed above, and thus, the wireless communicator 494 will not be discussed in further detail. Here, the substrate 486 supports the wireless communicator 494, and electrically connects the wireless communicator 494 to the electronic controller 492 via the substrate 486. The wireless communicator 494 is configured to receive electric power from the rechargeable power source 482 via the substrate 486. Preferably, the electronic controller 492 is configured to control the supply of electric power from the rechargeable power source 482 to the wireless communicator 494.

The electrical unit 470 further comprises an antenna 496. The antenna 496 is configured to receive and transmit wireless signals from the wireless communicator 494. The antenna 496 is provided to the substrate 486 and electrically coupled to the wireless communicator 494. Here, the antenna 496 is provided to the second side 486b of the substrate 486, and is electrically coupled to the wireless communicator 494. A signal amplifier can be provided to the substrate 486 for selectively amplifying the signals of the antenna 496 as needed and/or desired.

The electronic controller 492 is configured to control supply of electrical power from the rechargeable power source 482 to the wireless communicator 494 based on an output from a detector 498. The detector 498 is configured to detect a state of at least one of the bicycle B and the bicycle component BC (e.g., the first operating device 12). For example, the detector 498 is a wake up detector that is configured to detect a vibration, and/or a movement of the bicycle B or the bicycle component BC that is indicative of the bicycle B and/or the bicycle component BC being used. Here, in the third embodiment, the wake up detector 498 is provided on the substrate 486. The electrical unit 470 also further comprises a SOC detector and a notification device similar to the SOC detector and a notification device of the electrical unit 70.

In the prior embodiments, the electrical units 70, 270, 370 and 470 can be modified such that the rechargeable power sources 82, 282, 382 and 482 can be charged wirelessly. In the modification where the rechargeable power sources 82, 282, 382 and 482 can be charged wirelessly, the rechargeable power sources 82, 282, 382 and 482 are provided so as to be not detachably from the electrical units 70, 270, 370 and 470. For example, in the first embodiment, the power source cover 78 can be fixed to the accommodating part 76 by one or more fixing bolts. Also, for example, in the second embodiment, the power source cover 278 and the opening 276b can be omitted.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the bicycle component. Accordingly, these directional terms, as utilized to describe the bicycle component should be interpreted relative to a bicycle in an upright riding position on a horizontal surface and that is equipped with the bicycle component. The terms “left” and “right” are used to indicate the “right” when referencing from the right side as viewed from the rear of the bicycle, and the “left” when referencing from the left side as viewed from the rear of the bicycle.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle component comprising:
a rechargeable power source configured to be charged by electric power from an external power supply; and
an electrical switch configured to be activated by only electric power from the rechargeable power source.

2. The bicycle component according to claim 1, further comprising
a holding structure configured to detachably hold the rechargeable power source to the bicycle component.

3. A bicycle component comprising:
a rechargeable power source configured to be charged by electric power from an external power source;
an electrical switch configured to be activated by electric power from the rechargeable power source; and
a holding structure configured to detachably hold the rechargeable power source to the bicycle component.

4. The bicycle component according to claim 2, wherein
the holding structure includes an electrical terminal structure electrically coupling the rechargeable power source to the bicycle component.

5. The bicycle component according to claim 2, wherein
the holding structure includes an accommodating part and a power source cover,
the accommodating part is configured to accommodate the rechargeable power source,
the accommodating part includes an opening for removing the rechargeable power source from the holding structure, and
the power source cover is configured to at least partially cover the opening of the accommodating part.

6. The bicycle component according to claim 5, wherein
the holding structure includes a cover fixing structure configured to fix the power source cover relative to the accommodating part.

7. The bicycle component according to claim 1, further comprising
a base member configured to be mounted to a bicycle; and
an operating member movably coupled relative to the base member.

8. The bicycle component according to claim 7, wherein
the operating member is configured to operate an operated device mounted to the bicycle.

9. The bicycle component according to claim 7, wherein
the operating member is configured to activate the electrical switch in response to an input to the operating member.

10. The bicycle component according to claim 7, further comprising
an additional operating member movably coupled relative to the base member, the additional operating member being different from the operating member.

11. The bicycle component according to claim 10, wherein
the additional operating member is configured to operate an additional operated device mounted to the bicycle.

12. The bicycle component according to claim 10, wherein
the base member includes a proximal end configured to be mounted to the bicycle, and a distal end opposite to the proximal end,
the additional operating member is pivotally supported by an axle to pivot with respect to the base member, and
the axle is disposed closer to the distal end than to the proximal end.

13. The bicycle component according to claim 10, wherein
the electrical switch is provided to at least one of the operating member and the additional operating member.

14. The bicycle component according to claim 10, further comprising
a hydraulic unit configured to operate the additional operated device in response to an input to the additional operating member.

15. The bicycle component according to claim 10, wherein
the operating member is movably mounted to the additional operating member.

16. The bicycle component according to 1, further comprising
a charging port configured to supply electrical power to the rechargeable power source from the external power supply.

17. The bicycle component according to claim 16, further comprising
a cover member configured to cover the charging port in a case where the cover member is in a covering state.

18. The bicycle component according to claim 1, further comprising
a wireless communicator electrically coupled to the rechargeable power source.

19. The bicycle component according to claim 18, wherein
the wireless communicator is configured to transmit information related to the rechargeable power source to an external device.

20. The bicycle component according to claim 18, further comprising
a substrate supporting the wireless communicator; and
an antenna provided to the substrate and electrically coupled to the wireless communicator,
the substrate being disposed between the rechargeable power source and the antenna.

21. The bicycle component according to claim 20, wherein
the antenna is disposed along a peripheral edge of the substrate.

22. The bicycle component according to claim 5, further comprising
a wireless communicator electrically coupled to the rechargeable power source;
a substrate supporting the wireless communicator on a first side; and
an antenna provided to a second side of the substrate and electrically coupled to the wireless communicator, the second side faces in an opposite direction to the first side, the rechargeable power source is closer to the power source cover than the antenna.

23. The bicycle component according to claim 20, further comprising
an electronic controller configured to control supply of electrical power from the rechargeable power source to the wireless communicator based on an output from a detector, the detector being configured to detect a state of at least one of the bicycle and the bicycle component.

24. The bicycle component according to claim 1, further comprising
an electronic controller configured to obtain information related to the rechargeable power source.

25. The bicycle component according to claim 24, further comprising
a notification device electrically coupled to the electronic controller, the electronic controller being configured to control the notification device based on the information.
